(19) United States
(12) Patent Application Publication
(10) Pub. No.: US 2013/0113648 A1
(43) Pub. Date: May 9, 2013

(54) SENSOR HEAD

(71) Applicants: Herbert Duvoisin, III, Orlando, FL (US); Douglas O. Carlson, Winter Garden, FL (US); Glen A. Holman, Orlando, FL (US); Kevin L. Johnson, Ocoee, FL (US); Waymond Scott, Lilburn, GA (US); Christopher Gary Sentelle, Orlando, FL (US); Geoffrey Solomon, Mount Dora, FL (US); Joshua L. Tabony, Fredericksburg, VA (US); Juan Antonio Torres-Rosario, Orlando, FL (US); Marquette Trishaun, Orlando, FL (US)

(72) Inventors: Herbert Duvoisin, III, Orlando, FL (US); Douglas O. Carlson, Winter Garden, FL (US); Glen A. Holman, Orlando, FL (US); Kevin L. Johnson, Ocoee, FL (US); Waymond Scott, Lilburn, GA (US); Christopher Gary Sentelle, Orlando, FL (US); Geoffrey Solomon, Mount Dora, FL (US); Joshua L. Tabony, Fredericksburg, VA (US); Juan Antonio Torres-Rosario, Orlando, FL (US); Marquette Trishaun, Orlando, FL (US)

(73) Assignee: L-3 COMMUNICATIONS CYTERRA CORPORATION, Orlando, FL (US)

(21) Appl. No.: 13/593,988

(22) Filed: Aug. 24, 2012

Related U.S. Application Data
(63) Continuation-in-part of application No. 13/249,519, filed on Sep. 30, 2011.

(51) Int. Cl. G01S 13/88

(52) U.S. Cl. CPC G01S 13/887
USPC 342/22

(57) ABSTRACT

Detection systems for scanning regions are disclosed. The detection systems may be used to detect various objects that are, for example, buried in the ground or obscured by being hidden on the body of a person. The detection systems include a sensor head having a continuous wave metal detector (CWMD) coil, radar antennas, and a transceiver electrically connected to a radar. The radar includes a transmit antenna configured to transmit electromagnetic radiation, and a receive antenna configured to sense electromagnetic radiation.

### CROSS-REFERENCE TO RELATED APPLICATION

The present application is a continuation-in-part of U.S. patent application Ser. No. 13/249,519, filed Sep. 30, 2011. The contents of the prior application are incorporated herein by reference in their entirety.

### TECHNICAL FIELD

This disclosure relates to a sensor head.

### BACKGROUND

A large percentage of land mines contain some amount of metal. Many versions of mines use metal for firing pins, shrapnel, and portions of the casing. If a mine has a sufficient quantity of a detectable metal, that mine can be found using a metal detector.

### SUMMARY

An apparatus that includes a sensor head with both a GPR and a continuous-wave metal detector is disclosed. In some implementations, the sensor head also includes a transceiver that is electrically coupled to and in communication with the GPR. Techniques for processing data from the GPR to determine whether a low-metal or no-metal threat object (such as small wires associated with explosives or bulk explosives that include little to no metal) are described.

In one general aspect, an apparatus includes a sensor head including a continuous wave metal detector (CWMD), a radar, and a transceiver electrically connected to the radar. The radar includes a transmit antenna configured to transmit electromagnetic radiation, and a receive antenna configured to sense electromagnetic radiation. The transceiver is enclosed in a metal housing.

Implementations may include one or more of the following features. The apparatus may include an extendable wand coupled to the sensor head. When the wand is collapsed, the wand and the sensor head may collapse to fill a volume that is smaller than a volume filled by the sensor head and the wand when the wand is extended. The transmit antenna may include an elongated spiral antenna, and the receive antenna may include an elongated spiral antenna. At least one of the transmit antenna or the receive antenna may be oriented at an angle relative to a normal of a bottom of the sensor head, and the angle may be greater than zero. Both the transmit antenna and the receive antenna may be oriented at the angle relative to the normal of the bottom of the sensor head. The angle may be between five and twenty degrees. The receive antenna may include a first receive antenna and a second receive antenna separate from the first receive antenna. The transceiver may be positioned between the receive antenna and the transmit antenna. The CWMD may include a transmit coil and a receive coil, and at least a portion of the transmit and receive coil may be positioned along a perimeter region of the sensor head. The GPR and the transceiver may be encircled by the transmit coil winding. The radar includes a ground penetrating radar. A cover may be configured to enclose at least a portion of the transmitter, the radar and the CWMD.

The apparatus may include a processor and electronic storage in communication with the sensor head, the electronic storage including instructions that, when executed, cause the processor to access data from the CWMD and from the radar, determine a signature of an object detected by one or more of the CWMD or the radar based on the accessed data. An output device may be configured to provide an indication of a detection of an object made by one or more of the CWMD or the radar. The CWMD may transmit and receive radiation at twenty-one or more different frequencies. The apparatus may include a support that receives the radar and the transceiver. The support may include a plastic grid.

In another general aspect, a kit includes a radar including a transmit antenna configured to transmit electromagnetic radiation, and a receive antenna configured to sense electromagnetic radiation, a continuous wave metal detector (CWMD), a transceiver enclosed in a metal housing, the transceiver including an interface configured to electrically connect the transceiver to the transmit antenna and the receive antenna, and a support structure configured to receive the transmit antenna, the receive antenna, the CWMD, and the transceiver, the support structure including a connector configured to electrically connect the transceiver to an electronic processor.

In another general aspect, an apparatus includes a sensor head including a continuous wave metal detector (CWMD), a radar, and a transceiver electrically connected to the radar, where the radar includes a transmit antenna configured to transmit electromagnetic radiation, and a receive antenna configured to sense electromagnetic radiation, each of the transmit and receive antennas includes an elongated spiral antenna, and the transceiver is positioned between the transmit antenna and the receive antenna.

In another general aspect, an apparatus includes a sensor head including a continuous wave metal detector (CWMD), a radar, and a transceiver electrically connected to the radar, the CWMD incudes a transmit coil and a receive coil, where the radar includes one or more transmit antennas configured to transmit electromagnetic radiation and one or more receive antennas configured to sense electromagnetic radiation, and the transceiver is enclosed in a housing. The continuous wave metal detector may be configured to transmit and receive radiation in the frequency band between about 300 Hz and about 180 kHz, and the radar may be configured to transmit and receive radiation in the frequency band between about 100 MHz and about 8 GHz.

Implementations may include one or more of the following features. The apparatus may include a wand coupled to the sensor head. The wand may be composed of plastic or carbon fiber. The CWMD transmit coil may be positioned concentric with the receive coil in a dipole configuration or the CWMD transmit coil and receive coil may be arranged in a quadrapole configuration. The radar transmit and receive antennas may be encircled by the CWMD transmit coil and receive coil. The continuous wave metal detector may transmit and receive radiation on at least six different frequencies and up to forty-two different frequencies. In some configurations, the radar may include one transmit antenna and two or more receive antennas. In other configurations, the radar may include two or more transmit antennas and two or more receive antennas. The radar may include a ground penetrating radar.

In another general aspect, a kit includes a wand, a first sensor head configured to attach to the wand, a second sensor head configured to attach to the wand; a processor configured to be operatively coupled to the first sensor head and/or the second sensor head; and a first memory configured to be operatively coupled to the first sensor head, and a second memory configured to be operatively coupled to the second sensor head. The first sensor head includes a continuous wave metal detector (CWMD) with a transmit coil and a receive coil, a radar including one or more transmit antennas configured to transmit electromagnetic radiation, and one or more receive antennas configured to sense electromagnetic radiation, and a transceiver operatively coupled to the radar and enclosed in a housing. The second sensor head includes a non-continuous wave metal detector. The first memory includes instructions that when executed cause the processor to access data from the continuous wave metal detector and data from the radar, and to determine a signature of an object detected by one or more of the continuous wave metal detector or the radar based on the accessed data. The second memory includes instructions that when executed cause the processor to access data from the non-continuous wave metal detector, and to determine a signature of an object detected by the non-continuous wave metal detector.

Implementations of the kit may include one or more of the following features. The wand may be composed of plastic or carbon fiber. The transmit coil and the receive coil may be arranged in a quadrapole configuration or the transmit coils may be positioned concentric with the receive coil in a dipole configuration. The one or more transmit antennas and the one or more receive antennas may be encircled by the transmit coil and the receive coil. The CWMD may transmit and receive radiation on at least six different frequencies and up to forty-two different frequencies. The CWMD may transmit and receive radiation in the frequency band between 300 Hz and 180 kHz. In some configurations, the radar may include one transmit antenna and two or more receive antennas. In other configurations, the radar may include two or more transmit antennas and two or more receive antennas. The radar may include a ground penetrating radar configured to transmit and receive radiation in the frequency band between 100 MHz and 8 GHz. The non-continuous wave metal detector of the second sensor head may be a pulsed metal detector.

The kit may include a support structure that receives the radar and the transceiver and a cover configured to enclose at least a portion of the transceiver, the radar and the continuous wave metal detector (CWMD) coils. The cover may be composed of plastic and the support structure may be a plastic grid. The housing enclosing the transceiver may be coupled to the wand or located inside the sensor head.

Implementations of the techniques discussed above may include a method or process, a system or apparatus, a sensor head, a sensor, a kit, or computer software stored on a computer-accessible medium. The details of one or more implementations are set forth in the accompanying drawings and the description below. Other features will be apparent from the description and drawings, and from the claims.

### BRIEF DESCRIPTION OF THE DRAWINGS

FIGS. 1A and 1B show plan views of a detection system.

FIGS. 1C and 1D show views of the detection system when collapsed.

FIG. 1E shows a top view of a sensor head used in the detection system of FIGS. 1A-1D.

FIG. 1F shows a plan view of a cover for the sensor head of FIG. 1E.

FIG. 1G shows views of internal components of the detection system of FIGS. 1A and 1B.

FIG. 1H shows a view of a wand of the detection system of FIGS. 1A and 1B in a collapsed state.

FIG. 1I shows a view of an audio speaker that may be included in the detection system of FIGS. 1A and 1B.

FIG. 1J shows a view of the system of FIG. 1A in an extended state.

FIG. 1K shows a view of the system of FIG. 1A in a collapsed state.

FIGS. 1L and 1M show a housing used in the system of FIG. 1A.

FIG. 1N shows a plan view of another example sensor head.

FIG. 1O shows a top view of the sensor head of FIG. 1N.

FIG. 2 is an example process for determining a signature of an object.

FIG. 3 is an example process for discriminating among objects.

FIG. 4 is a scatter plot illustrating example feature values for multiple types of clutter and targets.

FIG. 5 shows an example of a multi-path process for analyzing sensor data.

FIGS. 6A and 6B show example data derived from data from the system of FIG. 1A.

FIG. 7A shows an example process for using frequency-domain data.

FIG. 7B shows another example process for using frequency-domain data.

FIG. 8 shows a computer system for use with the system shown any of the proceeding and subsequent FIGS.

FIG. 9A shows a perspective view of another example cover for a sensor head.

FIG. 9B shows a perspective view of another example sensor head.

FIG. 9C shows a plan view of an example coil for a CWMD.

FIG. 9D shows a plan view of a shield.

FIG. 9E shows a plan view of a grid and bottom for a sensor head.

FIG. 10A shows a perspective view of an example transceiver.

FIG. 10B shows a perspective view of the sensor head of FIG. 9B and an interface for connection to the transceiver of FIG. 10A.

FIG. 11 shows an exploded view of the example transceiver of FIG. 10A.

FIG. 12A shows a perspective view of another example sensor head.

FIG. 12B shows a perspective view of another example sensor head.

FIG. 13 shows a perspective view of another example sensor head.

FIG. 14 shows a perspective view of another example sensor head.

### Like reference numbers refer to like elements.

### DETAILED DESCRIPTION

A detection system for scanning a region is disclosed. The region may be, for example, the surface and subsurface of the ground or a space in the vicinity of a stationary portal through which persons and objects (such as luggage and cargo) pass. The region may be all or a portion of a person who is scanned with the detection system by a human operator. The detection system may be used to detect landmines and/or bulk explosives that are not necessarily included in a landmine. The system also may be used to detect metallic objects, such as small wires, objects that may or may not include metal, such as improvised explosive devices (IED5), and non-metallic objects, such as explosives that are buried in the ground or obscured by, for example, being hidden on the body of a person.

The system is lightweight, portable (by, for example, being hand-carryable and/or wearable), and has a rugged design and construction configured to withstand impacts and extreme climate conditions (for example, high winds, rain, snow, ice, and sand). By employing integrated electronics, sensor design, and light-weight construction techniques (for example, carbon fiber composite construction techniques) the system (which may be referred to as MINI-HSTAMIDS or MINI-H and may be applied to other handheld systems), has reduced size, weight and power compared to prior detection systems, while also having increased structural integrity. In some implementations, the system weighs about six pounds (about 2.7 kilograms) and collapses to a 14.3″×10.4″×4.6″ (about 36 cm×26 cm×11 cm) volume for belt, hand-carry, or backpack transport.

The sensor head may include radar antennas that transmit and receive electromagnetic radiation and are electrically coupled to a transceiver. The radar antennas may be part of a ground penetrating radar (GPR). The transceiver may be integrated into the sensor head or may be on the sensor head. In some implementations, the transceiver is located separate from the sensor head but is in communication with the sensor head. For example, the transceiver may be located in an electronics unit or an electronics housing that is coupled to a wand that is attached to the sensor head.

Inclusion of the transceiver in the sensor head simplifies cabling requirements between the sensor head and an electronics unit that is remote from the sensor head. For example, in some implementations, a thin, easily coiled universal serial bus (USB) data wire is employed instead of two relatively thick and long bend-radius coaxial cables. Some prior systems used coaxial cables to communicate data to an electronics unit separate and removed from the sensor head. For example, in some prior systems, the transceiver was located in a vehicle to which the sensor head was mounted. Integration of the transceiver with the sensor head results in the system being collapsible, small, and lightweight. Replacement of the thick non-coiling coax with the thin coiled wires, achievable due to the placement of the transceiver on, in, or near the sensor head, allows for the collapsible design.

Additionally, use of the thin, coil-able data wire may result in greater system performance due to the thin data wire providing lower noise data transmission and lower signal loss as compared to systems that use coaxial cable for data transfer. The replacement of the coaxial cables with the thin, coil-able single data cable may result in a two-fold or greater reduction in false alarm rate.

The sensor head also may include continuous-wave metal detector (CWMD) coils. The dynamic range of the CWMD allows the GPR and electronics associated with the GPR to be housed in the sensor head with the CWMD, integrated into the sensor head along with the CWMD, or otherwise placed near (for example, about a foot or less) the CWMD. Due to the dynamic range of the CWMD, the CWMD, or data from the CWMD, may be adjusted or otherwise compensated to account for the metal in the transceiver, whereas pulsed metal detectors generally cannot be compensated. The ability of the CWMD to adjust to the transceiver metal allows for the transceiver to be placed in the sensor head or near the sensor head. Moreover, a CWMD may be able to detect items that a typical pulsed metal detector is not able to detect, such as non-ferrous metals.

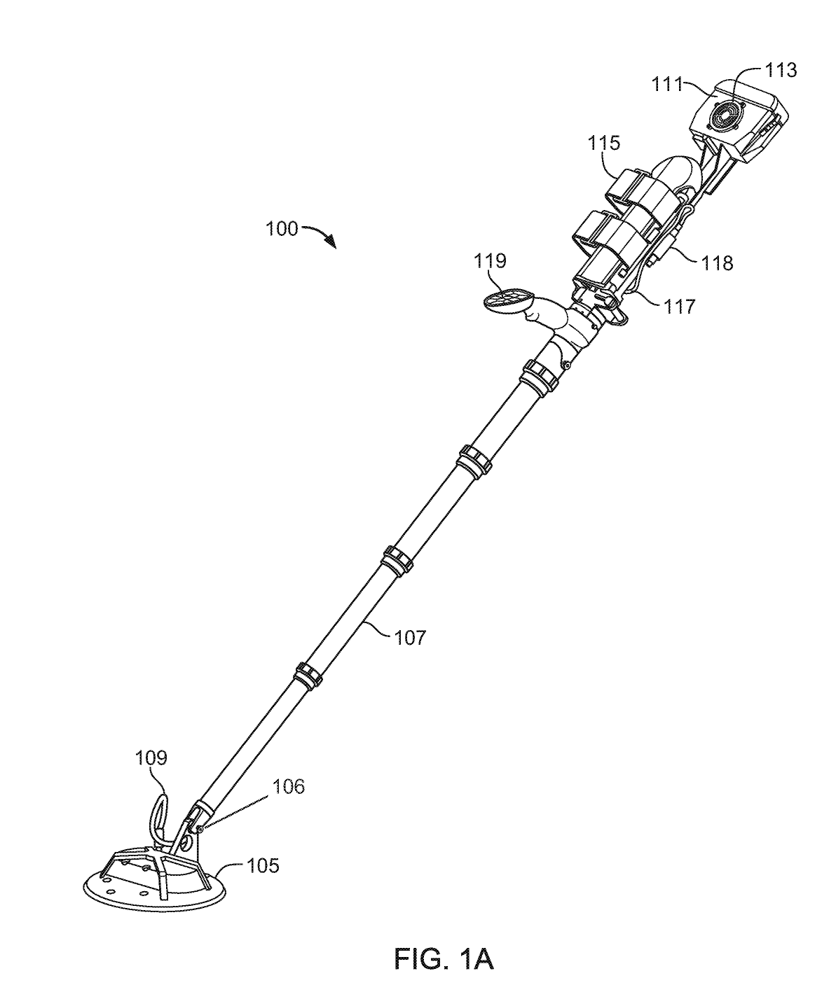

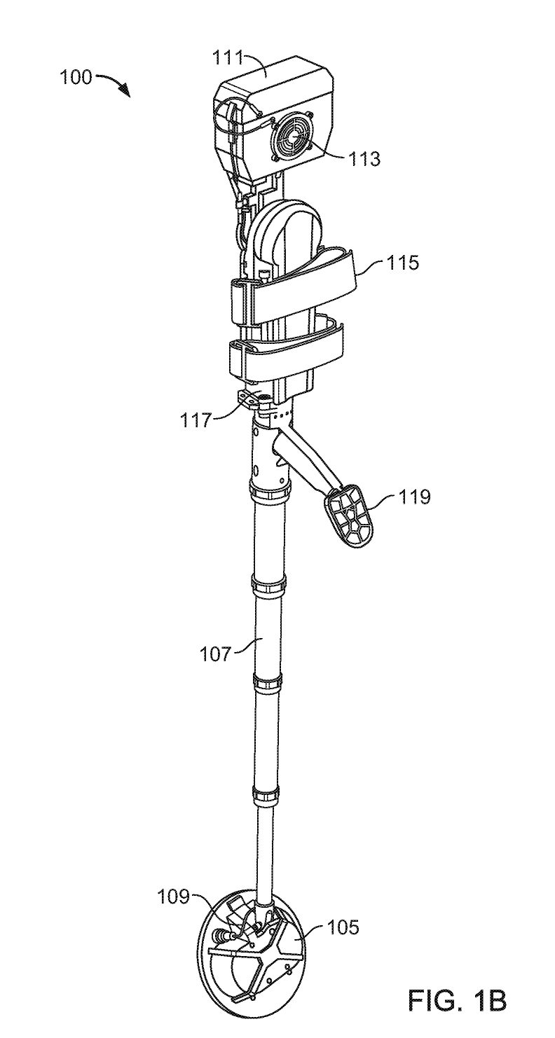

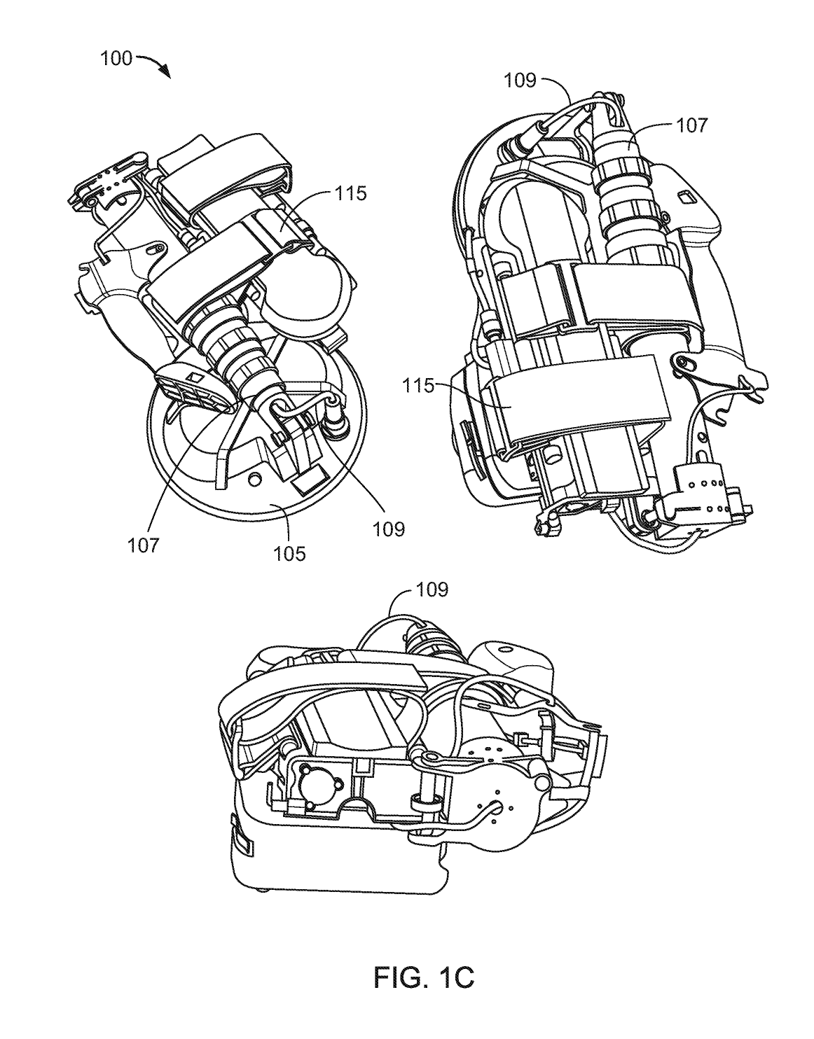

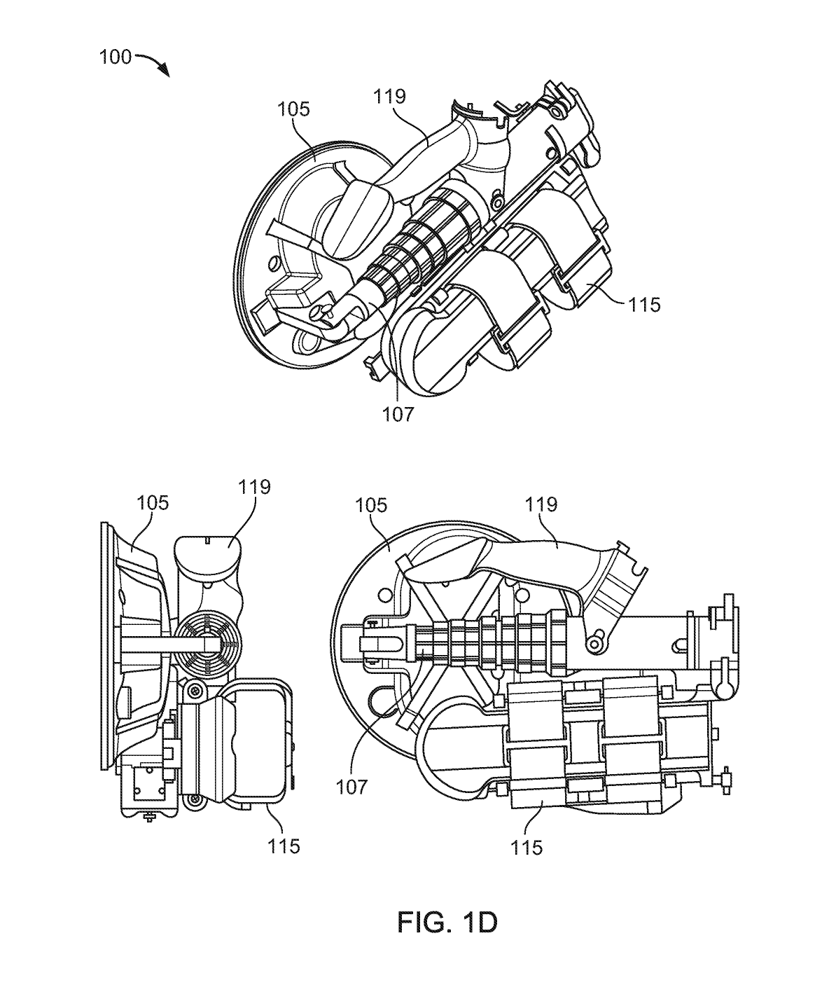

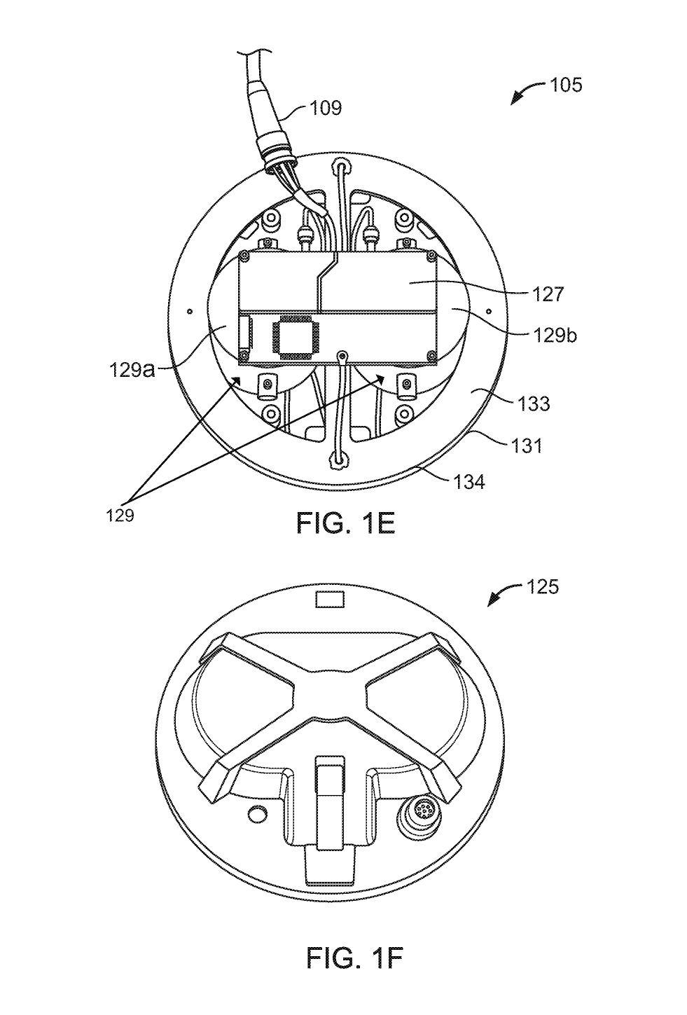

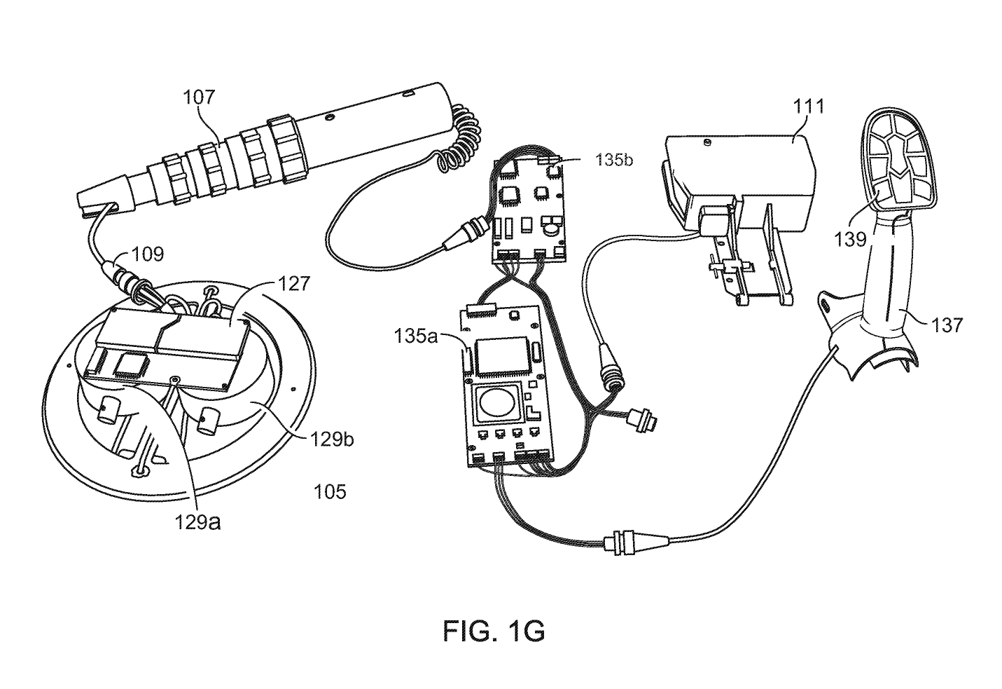

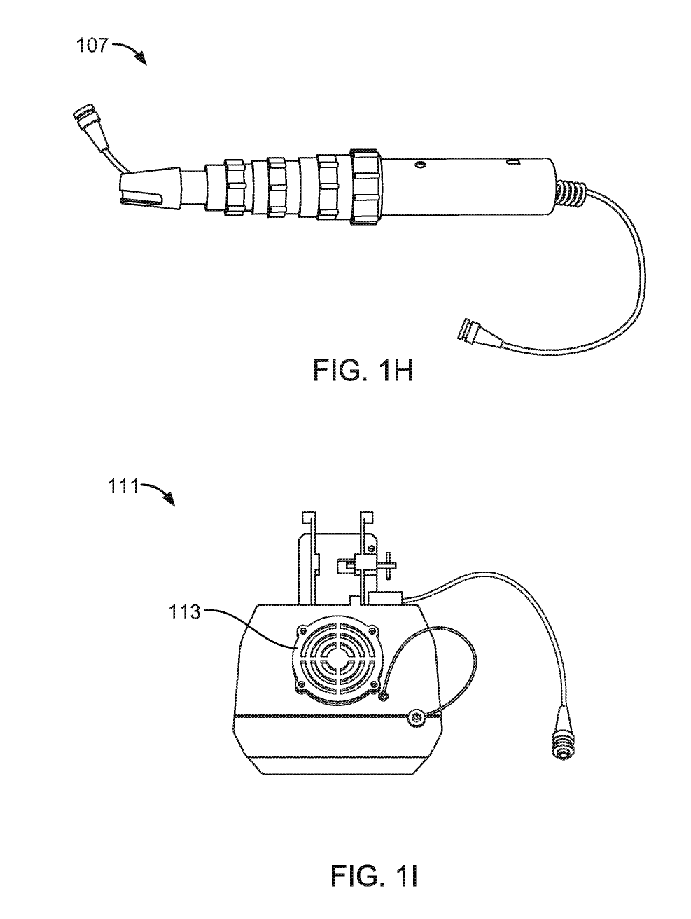

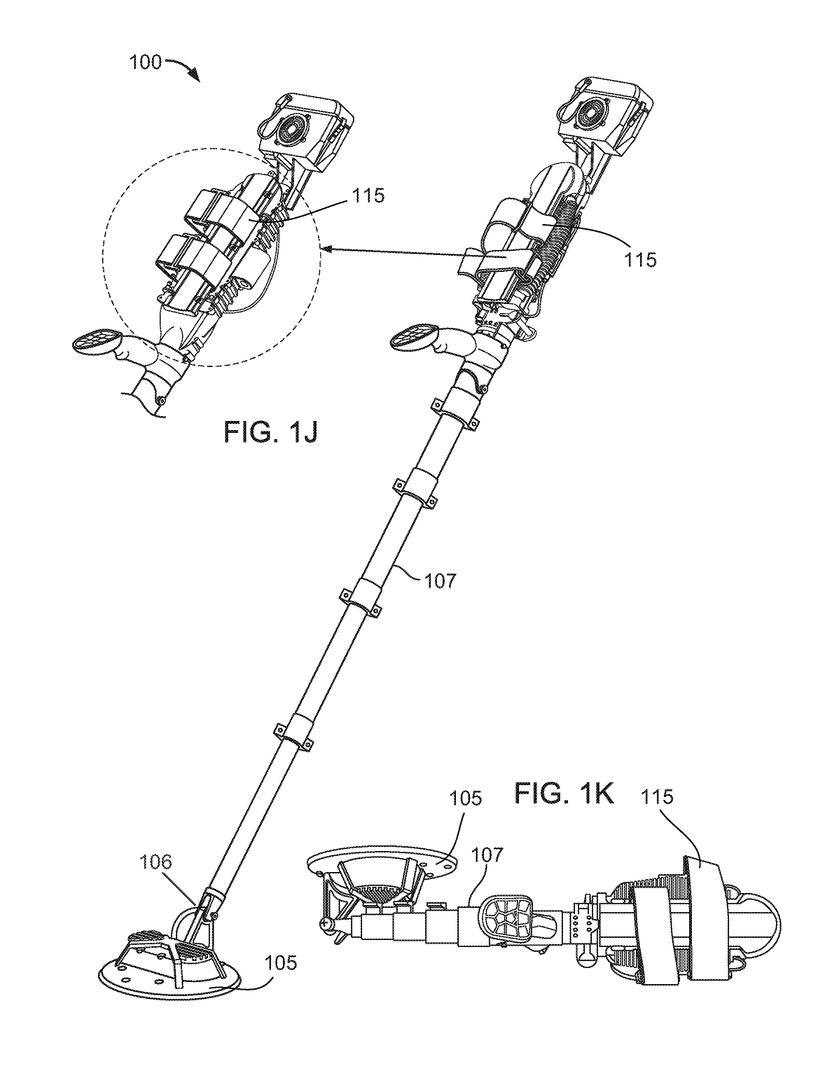

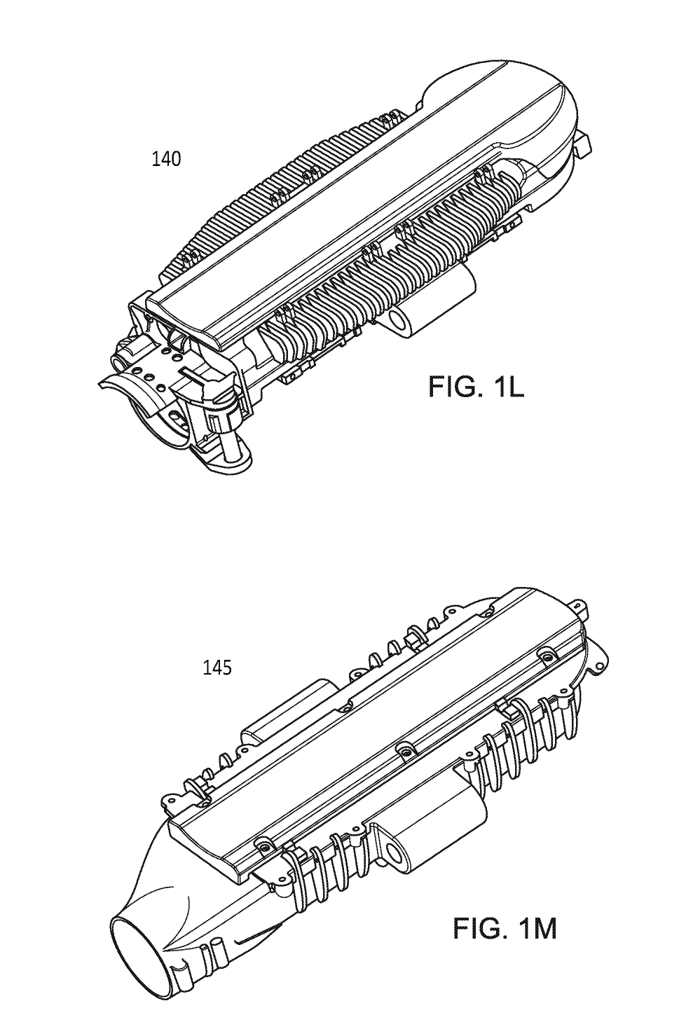

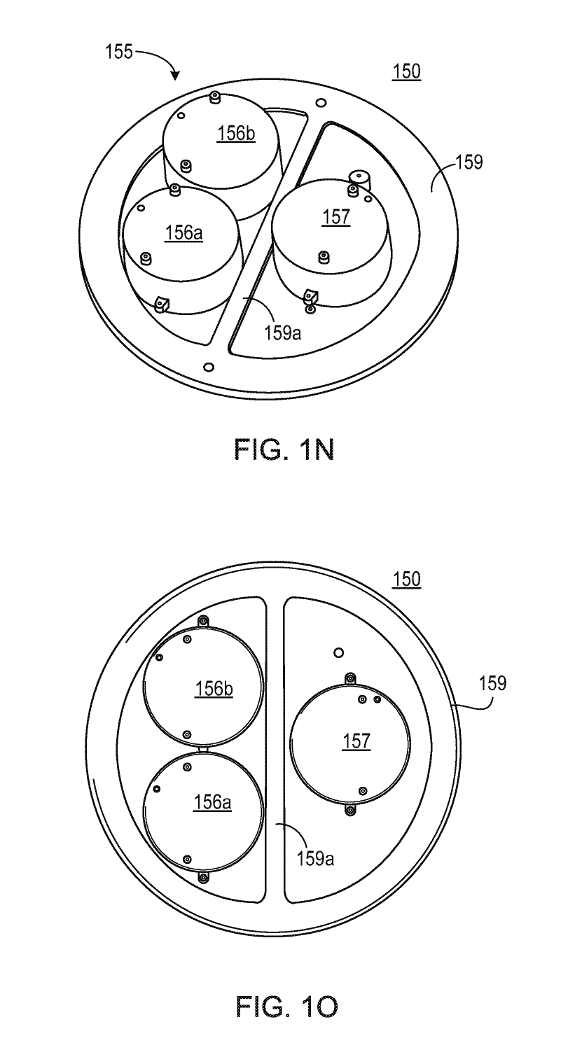

Referring to FIGS. 1A and 1B, the detection system 100 includes a sensor head 105 attached to a wand 107. A transceiver 127 (FIG. 1E) is included in the sensor head 105 such that the cabling that carries data to and from the sensor head 105 may be simplified. In this example, a cable 109 provides data communications between the sensor head 105 and electronics (not shown), such as an electronic storage and an electronic processor, included in a module 111 and/or an electronics housing 118 (FIGS. 1L and 1M). In addition, the sensor head 105 is configured such that it may be detachable using fastener 106. The module 111 also may include a speaker 113 or other output (such as a display, not shown) that provides an indication to an operator of the system 100 that a target has been detected.

The system 100 also includes a platform 115 that is sized to fit an arm of a human operator or a robotic system. The platform 115 opens on a bottom end 117 to a grip 119. The operator of the system 100 may control the motion and location of the sensor head 105 by grasping or otherwise contacting the grip 119 and moving the wand 107 through a range of motion. The platform 115 also forms a portion of an electronics housing 118.

FIGS. 1C and 1D show views of the detection system 100 when the wand 107 is collapsed and the sensor head 105 is folded into the wand 107.

FIG. 1E shows a top view of the components of the sensor head 105 without a cover 125 (FIG. 1F). The sensor head 105 includes a GPR 129, a transceiver 127, and a CWMD 133. The GPR 129 includes a receive antenna 129a and a transmit antenna 129b. The GPR 129 may be a stepped-frequency continuous-wave GPR (a GPR with a non-pulsed signal). The low-profile of a stepped-frequency continuous wave (SFCW) GPR antenna configuration allows a reduction in the overall height and contour of the sensor head 105, making collapse and visual registration with the ground easier for the user.

The GPR 129 includes a transmit antenna 129a and a receive antenna 129b. The transmit antenna 129a transmits electromagnetic signals in a particular frequency band, and the receive antenna 129b receives (detects or otherwise senses) signals from the surrounding environment that arise in response to being irradiated with the signals from the transmit antenna 129a. The frequency band of the GPR may be approximately 100 MHz to 8 GHz or any frequency band within that frequency range.

The transceiver 127 may be a radar transceiver. The transceiver 127 may allow for simplified cabling and the elimination of a microwave cable between the sensors (such as the GPR 129) in the sensor head 105 and electronics (such as electronics 135a and 135b shown in FIG. 1G) in a separate part of the detection system. For example, rather than using a coaxial cable or cables, the transceiver 127 allows for a cable such as the cable 109 (which may be a USB cable) that provides communication between the GPR and electronics that are removed from the sensor head 105. Elimination of the microwave cable may result in less power dissipation and reduction in phase mismatch of the signals traveling in the microwave cable.

The sensor head 105 may operate in multiple modes, and a particular operating mode may be selected by the operator of the system 100 through the transceiver 127. The transceiver 127 may include a field-programmable gate array (FPGA) or other processor that allows selection from among multiple operating modes of the sensor head 105 or allows for programming of the FPGA. In some implementations, the user may manually select between the various operating modes. For example, the user may select an operating mode using an input/output device that is in communication with the transceiver 127. In some implementations, the operating mode may be selected beforehand.

The operating mode selectable through the transceiver 127 may be a mode that determines operating characteristics of the sensor, or sensors, included in the sensor head 105. For example, each of the operating modes of the GPR 129 may be associated with a different frequency band. A first operating mode may be an operating mode in which the GPR transmits signals in a frequency band from about 640 MHz to 3.4 GHZ, in steps of 20 MHz. Such an operating mode may be used in situations in which relatively deep penetration of the GPR signals is desired (such as when targets are buried deep in the ground) and when greater resolution of certain signal processing features (such as a mapping of the ground-air interface is desired). Another mode may be an operating mode in which the GPR 129 operates by transmitting signals in a frequency band from 1.3 GHz to 2.7 GHz in steps of 10 MHz. Such an operating mode has a frequency band approximately half as wide as the first mode. This operating mode may be used to, for example, reduce power consumption or to provide more energy (more signals) at a known frequency of interest or more energy in a frequency band of interest.

Although two modes are discussed above, the transceiver 127 may allow selection from among more than two operating modes. For example, a mode of operation may be a mode in which the GPR 129 switches among multiple operating modes in a predetermined, pseudo random, or random manner. In some implementations, the transceiver 127 may allow selection of a mode based on environmental conditions.

Referring also to FIG. 1F, a top view of a cover 125 for the sensor head 105 is shown. The cover 125 may fit over the components of the sensor head 105 to protect the components. The cover 125 may attach to the wand 107. The cover 125 also may attach to the sensor head 105. The sensor head 105 may be operated without the cover 125 present.

The sensor head 105 also includes a CWMD 133 that includes an upper shield 134 and a lower shield 131, with the transmit and receive coil (not shown) between the two shields.

In greater detail, the CWMD 133 produces or transmits an electromagnetic (EM) field at multiple frequencies through the transmit coil windings, and the produced EM field induces a current in metallic portions of items in the vicinity of the CWMD 133. The current induced in the metallic portions of the items produces a second EM field that is sensed by the receive coil windings of the CWMD 133. The second EM field sensed by the CWMD 133 is analyzed to further characterize the item. For example, the analysis may distinguish an item that is a target from an item that is a clutter object or part of the background.

The transmit coil of the CWMD 133 produces EM radiation at a number of frequencies, and the number of frequencies is sufficient to allow determination of a signature of an item that is independent of the item's orientation relative to the transmit and receive coil windings of the CWMD 133. The CWMD 133 may have more than six separate and distinct frequencies, the CWMD 133 may have twenty-one separate and distinct frequencies, or the CWMD 133 may have forty-two or more separate and distinct frequencies, or any other suitable number of frequencies.

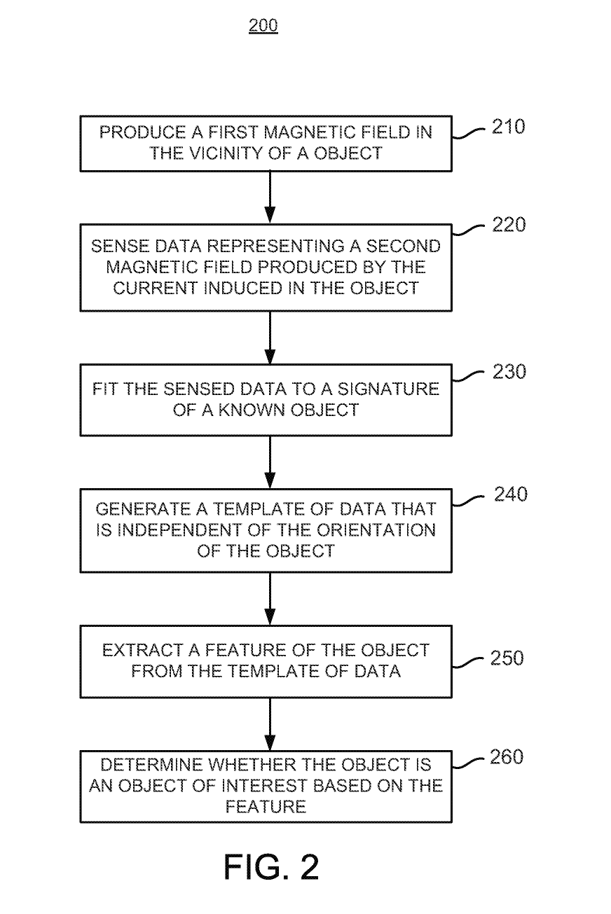

The CWMD 133 senses in-phase and quadrature (I&Q) data that represents the second EM field. As discussed with respect to FIGS. 2-4, sensing I&Q data at multiple frequencies allows determination of a signature of the target that is independent of the orientation and/or position of the target relative to the sensor. Thus, the signature of the target is the same, or substantially the same, for the target regardless of the position or orientation of the target relative to the sensor. The signature may allow improved detection of targets and/or improved discrimination between targets and clutter.

FIG. 1G shows internal components of the detection system 100 of FIGS. 1A and 1B. The detection system 100 includes the sensor head 105, the cable 109, the wand 107 (shown in a collapsed state in FIG. 1G), electronics 135a and 135b, module 111 (which may be a battery box module), and a hand control 137. The electronics 135a and 135b may, for example, include one or more processors and electronic storage modules that process data from the transceiver 127. The electronics 135a and 135b also may process data from a CWMD and other sensors that may be included in the sensor head 105. The electronics 135a and 135b may be included in the housing 118.

The hand control 137 (similar to the hand control 119 shown in FIG. 1A) provides the operator of the system with control over the position of the sensor head 105. Additionally, the hand control 137 includes an interface 139 that allows the user to program the transceiver 127 and/or select an operating mode for the GPR 129. The hand control 137 also may allow the user to set various system parameters, such as the volume or tone of a sound that alerts the user to a potential detection.

FIG. 1H shows a plan view of the wand 107 in a collapsed state, and FIG. 1I shows a plan view of the module 111. The module 111 includes a speaker 113 and provides an audio interface to the operator. A headphone set (not shown) that connects to the housing 118 or the module 111, and the speaker 113 may be included and may be used while operating the system 100 in, for example, demining operations, along with ancillary hardware. The speaker 113 and electronics associated with the speaker 113 support generation of constant and sweeping tones. For example, tones from a sensor (such as the CWMD 133 or GPR 129) may provide a tone “flip” or other audible indicator when passing over a target or in response to an item being in the vicinity of the sensor head 105. The module 111 and speaker 113 also supports more complex audio such as human voice. For example, voice outputs and other relatively complex tones may be recorded and stored for playback. The system 100 may include multiple operating modes with the recorded models for different targets (for example, mines as compared to improvised explosive devices (IEDs)).

The audio output may be one of three different types: (1) MD output, (2) GPR output or (3) system status output. The MD response sound may be a set of variable pitch and amplitude audio tones, while the GPR sounds may be discrete, wideband beeps. Other audio responses may be either distinct electronic tones or commands that are generated to inform the operator of system status through audible indicators alone. For example, a Battery Low Warning command may be generated within five minutes of battery life remaining All (built-in test) BIT Failure debug codes may be in spoken English. Examples of built-in tests include tests that run, continuously or periodically, to determine whether the GPR and CWMD are functioning properly or at all. When the GPR or CWMD are not operating properly, the BIT may produce an indicator to the operator of the system 100 such that the operator stops using the system 100 and/or repairs the system 100.

The system 100 stores the default audio mode and automatic target recognition (ATR) models in non-volatile memory enabling the system to remember the states even upon system shut down.

A battery (not shown) may be mounted into module 111 or directly to the rear of the module 111, or the system 100 may be powered by a battery that is external to the system 100. For example, an external battery may be mounted to a belt to form a belt-mounted battery configuration worn by an operator of the system 100. The belt-mounted battery configuration may be worn by an operator of the system 100, and the battery may be coupled to the module 111 (or another part of the system 100) to provide power to the system 100. A variety of battery types may be employed in the system, for example, a variety of military batteries may be employed.

An electronic processor included in or on the system 100 (such as in the electronics housing 118) or in communication with the system 100, may be accessed through a USB connection. For example, the electronic processor may be accessed at an external battery pack connector interface. This may add flexibility to the system 100. For example, the electronic processor may be programmed, reprogrammed, and selectable to address specific mine targets (or other specific types of hazardous objects of interest) and to address a specific region of operations via web access.

FIG. 1J shows another plan view of the system 100 with the wand 107 extended, and FIG. 1K shows another plan view of the system 100 with the wand 107 collapsed and the sensor head 105 folded (or collapsed) against the wand 107 to reduce the size of the collapsed system 100.

FIG. 1L shows a glued carbon fiber housing 140, and FIG. 1M shows an aluminum housing 145. The housings 140, 145 may be the electronics housing 118. The housings 140, 145 may house the electronics for the sensor head 105. The aluminum housing 145 allows dissipation of heat generated by the electronics housed by the housing 145. Any thermally conductive, lightweight material may be used to construct the housing 145. The housing 145 may be a two-piece housing that is sized to fit about the wand 107.

FIG. 1N shows a plan view of internal components of another example sensor head 150, and FIG. 1O shows a top view of the internal components of the sensor head 150. The sensor head 150 includes a GPR 155 and a CWMD 159. In some implementations, the sensor head 150 may include a transceiver (not shown) similar to the transceiver 127. The transceiver is in communication with the GPR 155. The transceiver may be located in the sensor head 150 (similar to the implementation shown in FIG. 1E), or the transceiver may be located outside of the sensor head 150. The sensor head 150 also includes cabling, electronics, and a rim to attach a cover similar to those discussed with respect to the sensor head 105. The sensor head 150 may be mounted on a wand such as the wand 107.

The sensor head 150 is similar to the sensor head 105, except the GPR 155 included in the sensor head 150 has two receive antennas, 156a and 156b and one transmit antenna 157. The inclusion of more than one receive antenna may improve performance by providing more samples of a region scanned by the sensor head 150. A portion 159a of the CWMD 159 passes between the two receive antennas 156a, 156b and the transmit antenna 157.

Although in the example of FIGS. 1N and 1O, the sensor head 150 includes two receive antennas 156a, 156b and one transmit antenna 157, this is not necessarily the case. The sensor head 150 may include more than two receive antennas, and each may be similar to the receive antennas 156a, 156b, and the sensor head 150 may include multiple transmit antennas, each of which may be similar to the transmit antenna 157. The addition of multiple GPR antennas provides the user with greater ground coverage area per sweep.

As discussed above, the system 100 provides a light-weight and portable sensor head. In addition to the various features discussed above, the system 100 also may include one or more electronic processors configured to process data collected by the sensors included in the sensor head 105 and the sensor head 150. Data processing techniques are discussed below, and these techniques may be applied to data collected by the sensors in the sensor head 105 and the sensor head 150. The data processing techniques discussed below also may be applied to data collected by other sensors. Further, the data processing techniques discussed below also may be applied to data as it is collected by a sensor (and may be stored temporarily in a buffer) or to data that was previously collected and stored in an electronic storage.

The system 100 includes several mechanical aspects. For example, the system 100 may be sealed against water and dust. The system 100 may include maintainability improvements that include using an aluminum piece electronics housing (such as the housing 145 of FIG. 1M) in place of carbon fiber (such as the housing 140 of FIG. 1L).

Referring to FIG. 2, a process 200 for determining a signature of an object is shown. The process 200 may be performed by one or more electronic processors associated with a sensor head such as the sensor head 105, the system 100, and/or the sensor head 150. The processor may be integrated with the sensor head or the sensor head may be separate and removed from the processor. In examples in which the sensor head is separate from the processor, the processor and the sensor head may be in communication while the sensor head is operating such that the processor receives data from the sensor head and analyzes the data as the sensor head operates. In the example discussed below, the sensor head is or includes a metal detector capable of sensing in-phase and quadrature data, such as the CWMD 133 or the CWMD 159. However, in other examples, the sensor head may include a different or additional sensor.

A first magnetic field is produced in the vicinity of an object (210). The object has an orientation relative to a direction of propagation of the first magnetic field and the first magnetic field induces a current in the object. In-phase and quadrature data representing the second magnetic field is sensed as a current arising in a coil of the sensor (220). The sensed data is fit to a two-dimensional signature (230). The two-dimensional signature may be a signature that represents the quadrature data as a function of the in-phase data.

A template of data that is independent of the orientation of the object relative to the first magnetic field is generated (240). The template of data also may be independent of an orientation of the object relative to a direction of propagation of radiation produced by the sensor and directed toward the target. The template of data may be a template that represents a three-dimensional object associated with a two-dimensional signature that matches, or closely matches, the two-dimensional signature found in (230). The three-dimensional object may be found from among multiple candidate three-dimensional objects by iterating through the potential three-dimensional space of I & Q data that could project into the two-dimensional signature found in (230). The number of candidate objects may be reduced by removing non-logical values (non-positive values) until the iteration converges to a unique candidate three-dimensional model that projects the two-dimensional I & Q signature found in (230) in real (positive) values.

In the model, the shape and material of each of the metallic objects is described using vectors representing amplitude and frequency, where frequency is the relaxation rate of the signature measured after being influenced by the electromagnetic field produced by the sensor. Because the three-dimensional model is a close approximation to the detected object, the orientation of the detected object relative to the sensor may be accounted for, and the vectors are independent of the relative orientation of the detected object and the sensor.

A feature of the object is extracted from the three-dimensional template (250). The feature of the object is extracted from data that is derived from, or produced by, the three-dimensional template, such as the amplitude and frequency vectors discussed above.

Extracting a feature of the object may include determining an amplitude of the second magnetic field and determining a frequency of the second magnetic field or the relaxation rate of the detected object after being influenced by the electromagnetic field produced by the sensor. Extracting a feature of the object may include identifying, from the frequency vector, a first frequency value and a second frequency value. Extracting a feature of the object may include identifying, from the amplitude vector, a first amplitude value and a second amplitude value. In some examples, the feature may include a ratio of the first frequency value and the second frequency value and a ratio of the first amplitude value and the second amplitude value. Using the ratio instead of the raw frequency and amplitude values as the extracted feature values may remove noise from the value of the feature, particularly if the noise is common to all frequency values and/or all amplitude values. The first and second frequency values may be the two highest frequency values, and the first and second amplitude values may be the two highest amplitude values. The first and second amplitudes may be the amplitudes respectively associated with the first and second frequencies.

In some examples, a distance between the detected object and the sensor may be estimated. The estimated distance between the detected object and the sensor may be used to normalize the data collected by the sensor to a constant, arbitrary distance before extracting the feature values of the amplitude and frequency. Determining the distance between the detected object and the sensor allows the extraction and/or use of additional features. For example, the distance itself may be used as a feature.

Whether the object is an object of interest is determined based on the extracted features (260). To determine whether the object is an object of interest, the extracted feature values may be input into one or more classifiers that are configured to produce a confidence value that may assume a range of numerical values, each of which indicates whether the object is more likely to be a target object or a clutter object. In some examples, the classifier is configured to produce a confidence value that is one of a discrete number of numerical values, each of which indicate whether the object is an object of interest (a target) or an object not of interest (clutter).

Although in the example process 200 discussed with respect to FIG. 2, the process includes determining the template of data that is independent of orientation (such as the three-dimensional object), this is not necessarily the case. In some implementations, data produced by the three-dimensional object is received by the processor from a pre-generated or separately generated template of data.

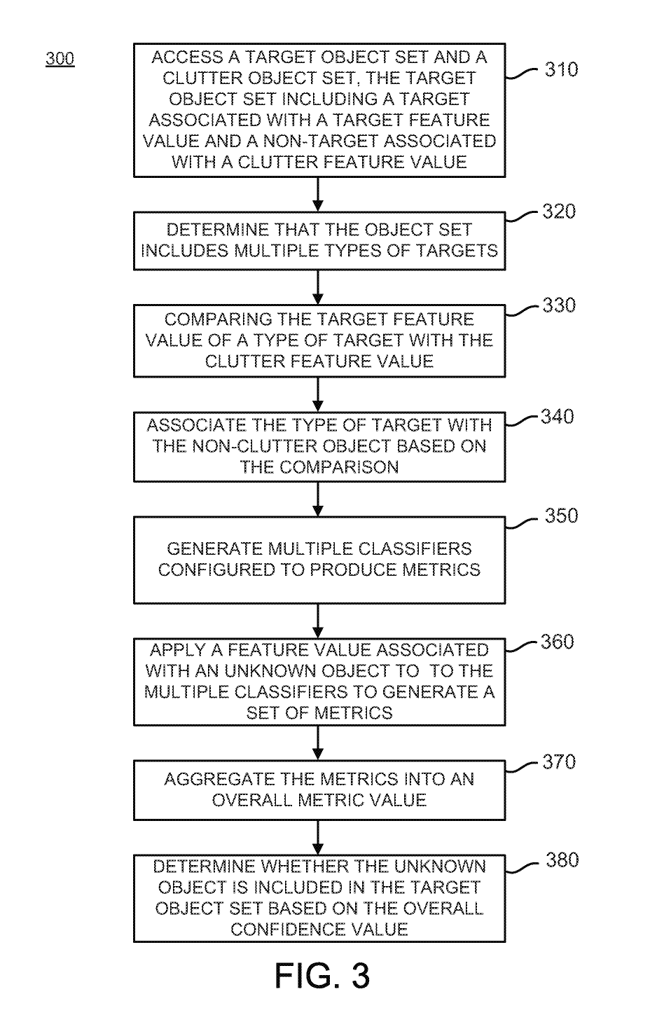

Referring to FIG. 3, an example process 300 for discriminating among objects is shown. The process 300 may be performed using data produced by the process 300 discussed with respect to FIG. 2. The process 300 may be performed by a processor integrated with a sensor head such as a sensor in the sensor head 105 or the processor may be separate from the sensor head. In examples in which the sensor head is separate from the processor, the processor and the sensor head may be in communication while the sensor head is operating such that the processor receives data from the sensor head, discriminates, and classifies the data detected by the sensor head as the sensor head operates.

In the discussion below, multiple classifiers are trained using data that is known to be associated with targets and data that is known to be associated with clutter. The training set includes multiple and distinct types of targets and/or multiple and distinct types of clutter. Each target type is paired, or grouped, with the type, or types, of clutters that are most closely associated with the target type. The grouped data is used to train a particular classifier. As a result, this classifier is tuned for the target-clutter pairing, or grouping, such that the classifier produces a metric or confidence value indicating that an object that has a feature similar to that of the targets in the target set is likely, or very likely, to be a target object. The other multiple classifiers are similarly trained using other clutter-target groupings or paring. Once trained, each of the classifiers produce, in response to an input representing a value associated with an object of unknown classification, a metric or confidence value that indicates whether the unknown object is more likely to be clutter or more likely to be a target. The metric of all of the classifiers may be aggregated to produce an overall metric for the unknown object. The overall confidence may produce a more accurate determination of whether the unknown object is a target as compared to using a single classifier.

In greater detail, a target object set and a clutter object set are accessed (310). The target object set includes a target that is associated with a target feature value and a non-target that is associated with a clutter feature value. For example, the target and clutter feature values may be a ratio of the frequency of relaxation of a metallic object detected by a CWMD sensor.

Whether the object set includes multiple types of targets is determined (320). The target object set may include multiple and distinct types of targets (such as different types of landmines, different types of trace chemicals used in the production of explosives, or different types of metallic pins used to ignite an incendiary device). Similarly, the clutter object set may include multiple and distinct types of clutter (such as different types of soils in which landmines are buried, different innocuous solids or liquids on which trace chemicals reside, or different types of foot wear in which incendiary devices are embedded). Continuing with the example in which a CWMD sensor is used for landmine detection, the sensor may encounter multiple different types of landmines, each having a different shape, size, and/or metal content, buried within different types of soils.

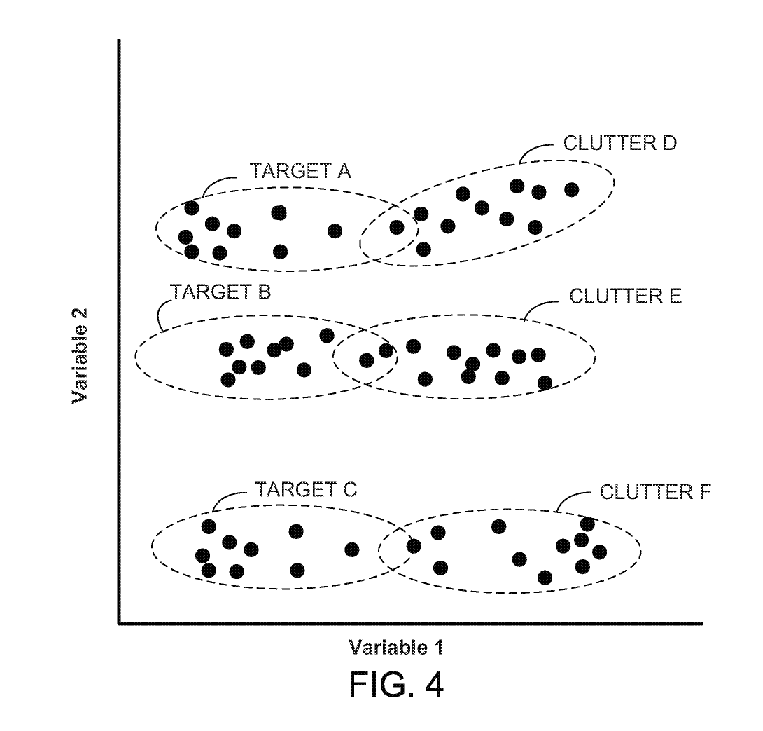

Referring also to FIG. 4, a scatter plot illustrating example feature values for target sets “A,” “B,” and “C” and clutter sets “E,” “F,” and “G” is shown. To create the scatter plot shown in FIG. 4, feature values associated with each of the targets in the three target sets and feature values associated with each of the clutter objects in the three clutter sets are plotted on a two-dimensional graph. In this example, there are three different target sets and three different clutter sets. In other examples, there may be more or fewer clutter and/or target sets, and the number of clutter sets and target sets is not necessarily the same. A target set (or clutter set) may be considered distinct from another target set (or clutter set) if the two sets do not overlap in feature space (such as the feature space shown in FIG. 4), or are less than a threshold distance apart. In the example of FIG. 4, “target A” and “target B” are considered to be distinct target types.

If the target set includes one type of target and the clutter set includes one type of clutter, the process 300 terminates.

A target feature value is compared to a clutter feature value (330). The types of targets and clutters that are closest to each other in the feature space represented in the scatter plot 400 are grouped or paired together. The targets and clutter may be grouped, paired, or otherwise compared using, for example, a nearest-neighbor analysis such that a particular type of target is paired with the clutter that is nearest in feature space. In another example, all target types are grouped with all clutter types that fall within a certain distance of each other in feature space. Regardless of how the target types are grouped with the clutter types, one target type may be associated with one clutter type or multiple target types may be associated with a lesser number of clutter types (or vice versa).

The type of target is associated with the type of clutter based on the comparison (340). As discussed above, the association may be made based on the closeness of the target type and clutter type in feature space. Referring again to FIG. 4, “target A” is associated, or paired, with “clutter D”, “target B” is associated with “clutter E”, and “target C” is associated with “clutter F.” Although in the example shown in FIG. 4, the paired targets and clutters overlap in feature space, this is not necessarily the case. In some examples, the paired targets and clutters may be close in feature space but not necessarily overlapping. For example, clutters and targets may be paired based on being the target and clutter that are closest to each other as compared to all other possible target and clutter pairings or groupings. Closeness in feature space may be determined by a distance metric such as, for example, a Mahalanobis distance, a linear distance metric, or a nearest neighbor analysis.

Multiple classifiers are generated (350). Each of the multiple classifiers is trained using a particular target-clutter grouping or pairing. The generated multiple classifiers may include various types of classifiers. For example, the multiple types of classifiers may include a multi-layer perceptron (MLP), a Bayesian classifier, radial basis function, Kohonen self-organizing map, a simplified fuzzy ARTMAP, and/or support vector machine (SVM).

Returning to the example of FIG. 3, “target A” and “clutter D” are used to train and generate a first classifier, “target B” and “clutter E” are used to train and generate a second classifier, and “target C” and “clutter F” are used to train and generate a third classifier. Thus, each of the generated classifiers is tuned to a particular target-clutter grouping or pairing. The classifiers each produce a confidence value or metric that indicates whether an unknown object is a target or a clutter based on a feature of the unknown object being input into the classifier. For example, the classifier that is trained on “target A” and “clutter D” data may produce a confidence of “1” (or 100%) when an unknown object having features similar to those in the “target A” set is received, indicating that the unknown object is a target. This same classifier may produce a confidence of “0.5” when an unknown object having a feature similar to that of a target in “target C” is received, indicating that the classifier has made a neutral decision as to whether the unknown object is a target. By individually training the classifiers in this manner, each of the classifiers is able to distinguish between clutters and targets that are very close in feature space. Due to their similarities, such targets and clutters may be difficult to distinguish using ordinary training techniques that do not segment the training data of clutter and/or targets into distinct types.

The trained classifiers are used to determine whether an unknown object is more likely to be a target or more likely to be clutter.

A feature value associated with an unknown object (an object that the classifiers have not encountered previously) is input to the multiple classifiers (360). The feature value may be, for example, a ratio of vector frequencies and amplitudes as discussed above. Each of the multiple classifiers into which the feature is input produce a metric that indicates how likely it is that the unknown object is a target.

The metrics from the multiple classifiers are aggregated into an overall metric (370). The overall metric may produce improved results as compared to techniques that determine whether an object is a target using a single classifier. The metrics may be aggregated by, for example, summing the metrics produced by each of the multiple classifiers. For example, the unknown object may be a target that is associated with a feature value similar to those of the targets in “target B.” Thus, the first classifier (trained using “target A” and “clutter D”) and the third classifier (trained using “target C” and “clutter F”) may produce a metric that indicates that the classifier is neutral as to whether the target is a clutter or a target. The neutral metric may be “0.5” on a scale of 0 to 1. In contrast, the second classifier (trained using “target B” and “clutter E”) may produce a metric that is very close to “1,” indicating that the unknown object has a high likelihood of being a target. Thus, in this example, the aggregated metric is the summation of the three metrics, and is “2.” An unknown object having characteristics of “clutter E” would have an aggregated metric of “1” because the second classifier would produce a metric of “0” and the first and third classifiers would each produce metrics of “0.5.” As a result, the use of multiple classifiers may improve performance as compared to techniques that use only one classifier. In this example, performance is improved because the metric of the target is further separated from that of the clutter. Moreover, if the feature values for the unknown objects in this example had both been input into the first classifier only, both objects would have the exact same metric of 0.5. As a result, the objects would not be distinguishable. Accordingly, training multiple classifiers and producing an overall metric as shown in this example may provide improved performance as compared to techniques that rely on a single classifier trained on non-segmented data.

In examples in which the multiple classifiers include classifiers of more than one type, the metric produced by each classifier may be normalized to a common scale. Such a normalization allows the metrics to be aggregated together without improperly or inadvertently weighting the output of a particular classifier as compared to the output of the other classifiers.

Whether the unknown object is a target is determined based on the overall metric (380). The unknown object may be considered to be a target if, for example, the overall metric exceeds a pre-determined threshold value.

In some implementations, whether an unknown object is a target may be determined purely from the signal being a specified level above the computed background. For example, if the signal exceeds a threshold that is set based on the background, the signal is deemed to be associated with a target. The signal may be based on, for example, the average amplitude from a subset of 21 frequencies measured by the CWMD.

In some implementations, the shape of the signal is employed in addition to or instead of the average amplitude of the frequencies. Discrimination between targets and clutter may be performed using a Support Vector Machine (SVM) classifier and a set of features derived from the distribution of the I/Q (for example, real/imaginary) frequency data measured at a 60 Hz rate by the CWMD sensor. An SVM may be used in, for example, scenarios in which a relatively small amount of data is collected. The set of features may include signal-to-noise ratio (SNR), the average real component across all frequencies measured by the CWMD, and a set of Discrete Spectrum of Relaxation Frequency (DSRF) values. The DSRF values may be a an amplitude and frequency vector, and the DSRF value of an object is independent of an orientation of the object relative to the CWMD. The DSRF values are unique for different types and shapes of metal and thus provide a measure for quantifying the detection signature. For example, the mineralized rocks (rocks that have a non-zero metal content) have a flat signature, whereas mines and man-made clutter are curved and/or angled. The DSRF values may be unique for different types and shapes of metal and thus provide an measure for quantifying the detection signature. The DSRF values may be computed with data collected at 15 or more frequencies at which the CWMD operates. For example, the DSRF values may be computed based on data collected at 21 frequencies.

The processing discussed with respect to FIGS. 2-4 may be applied to data collected by a CWMD included in the sensor head 105 or the sensor head 150. As discussed above, the sensor head 105 and the sensor head 150 may include a CWMD and a GPR, and data from both of these sensors may be analyzed to determine whether a particular detection is a target (such as a mine or an IED).

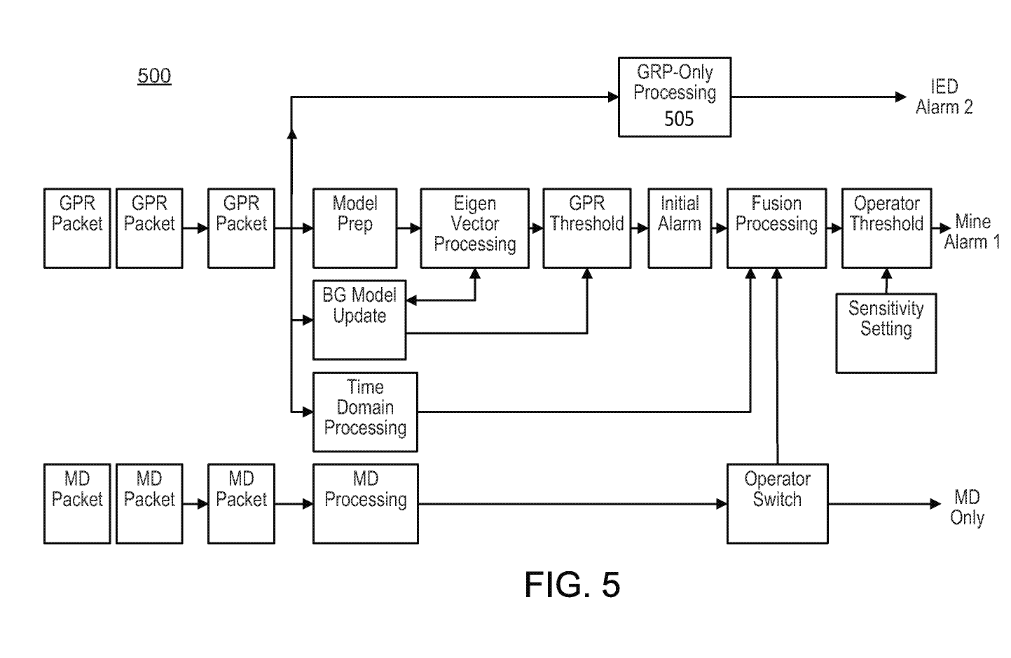

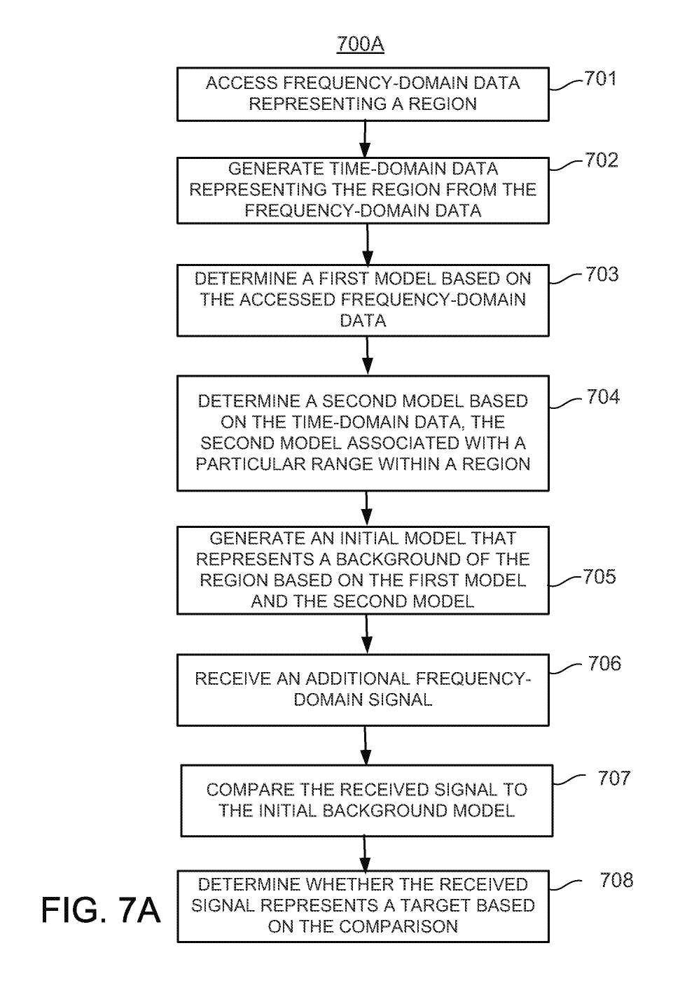

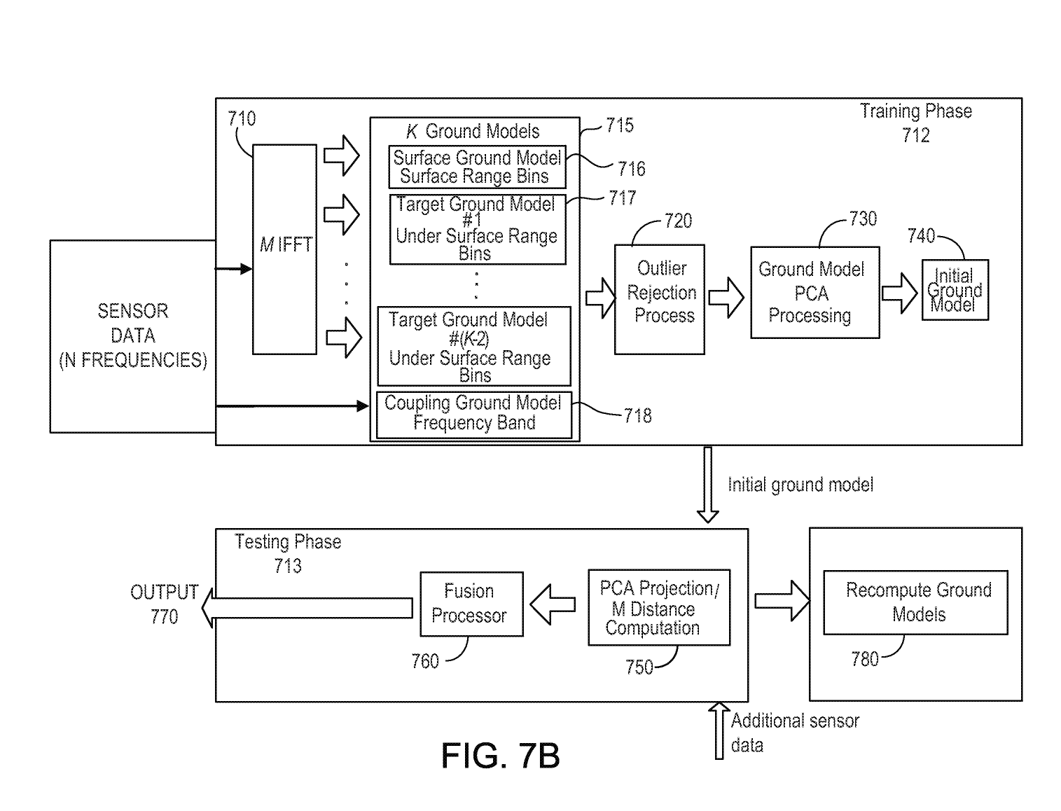

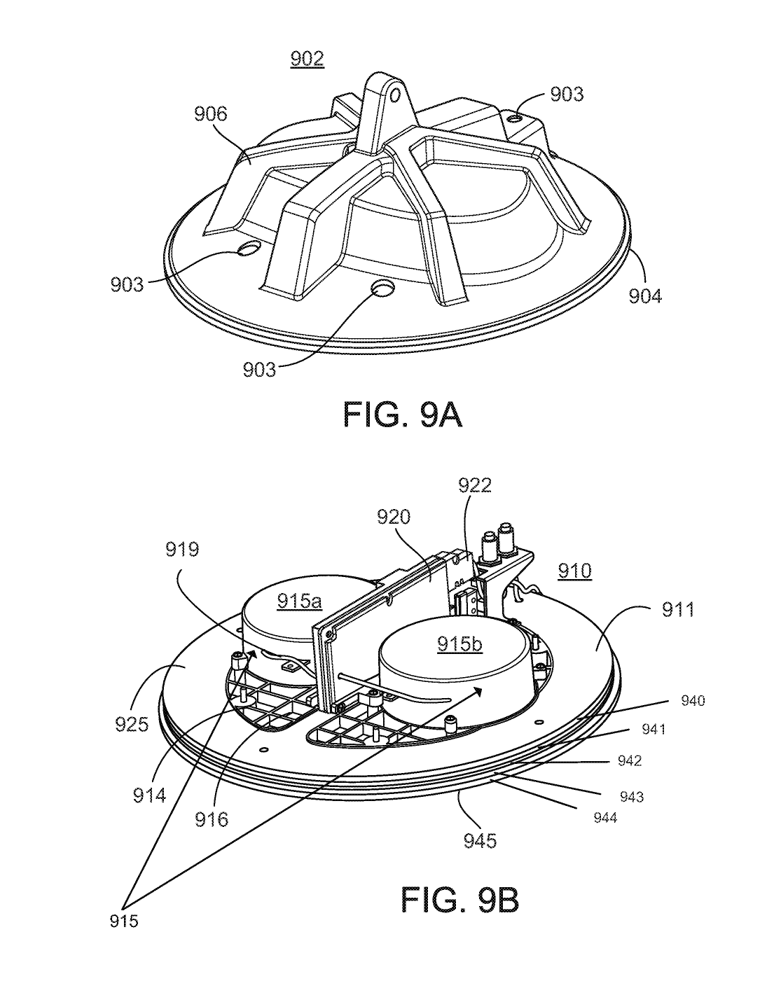

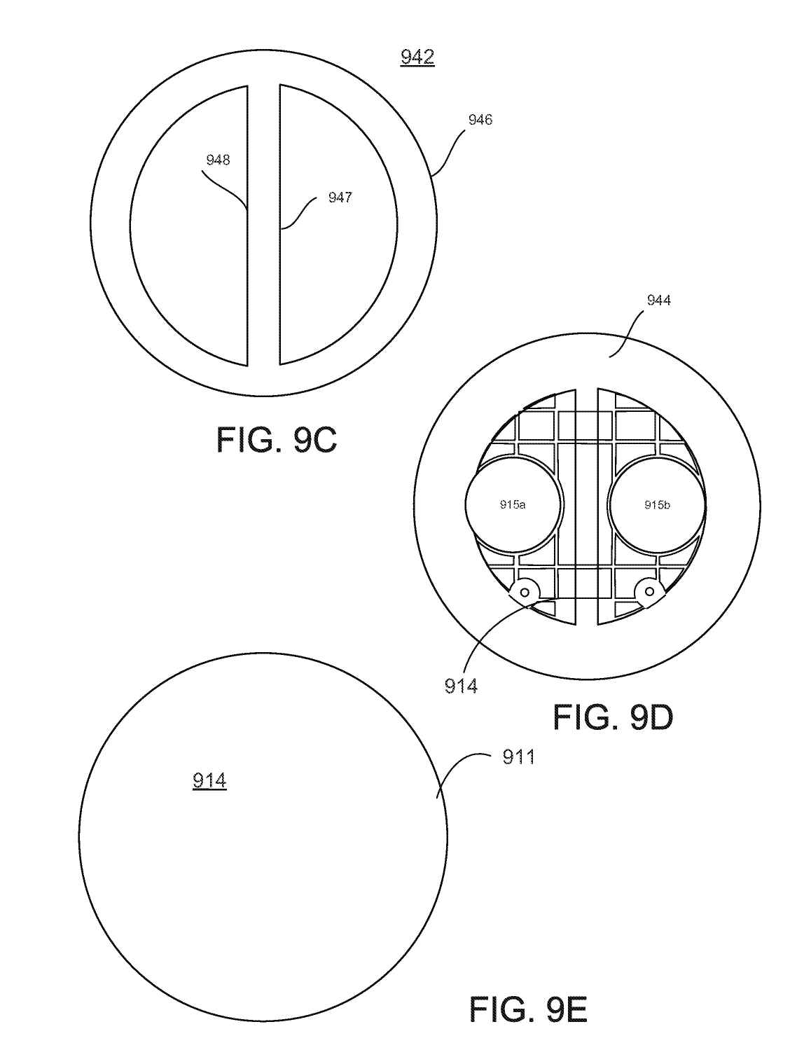

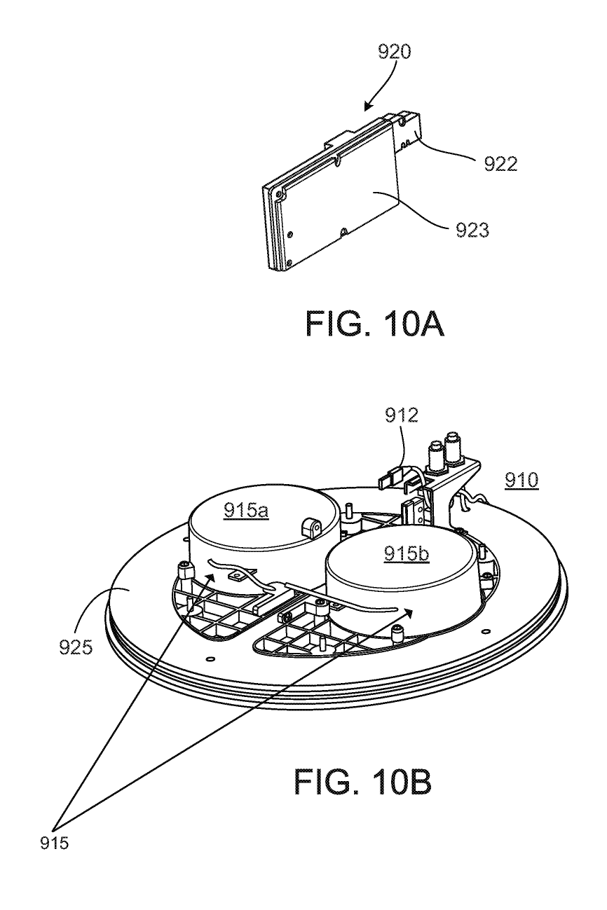

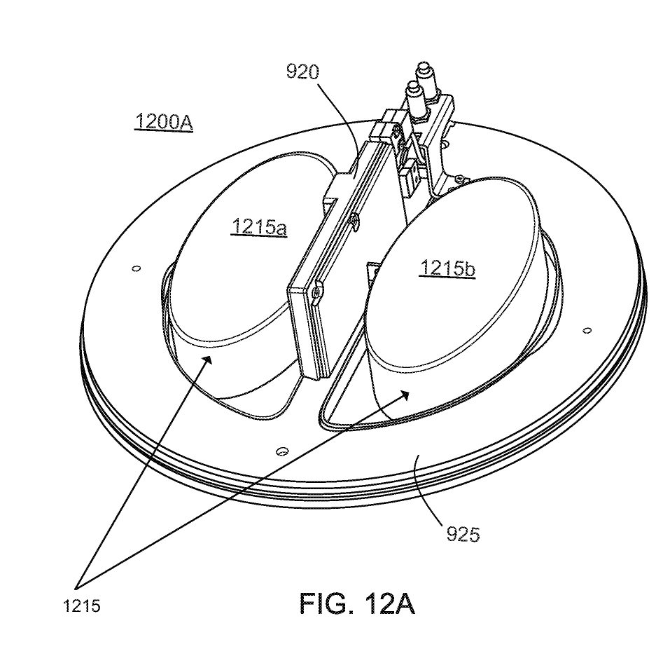

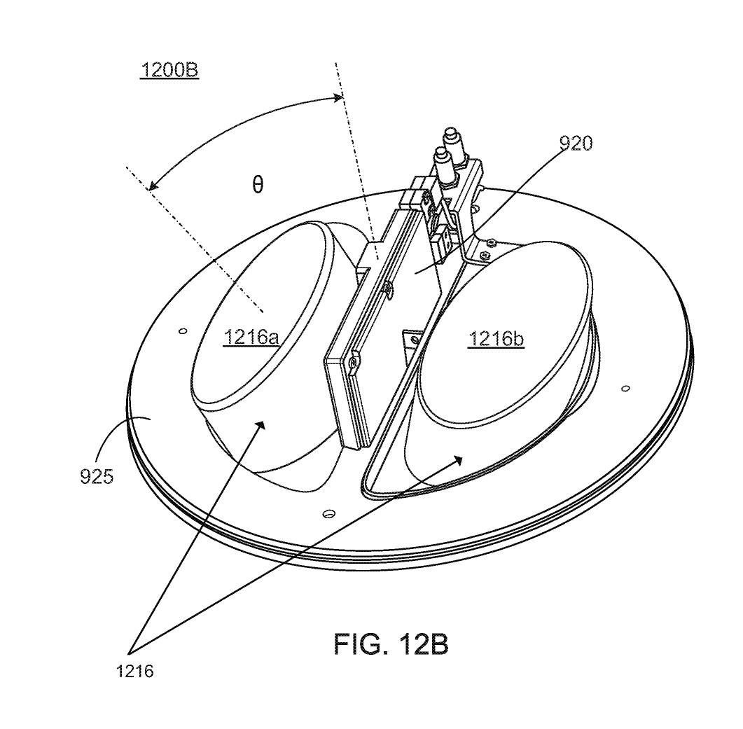

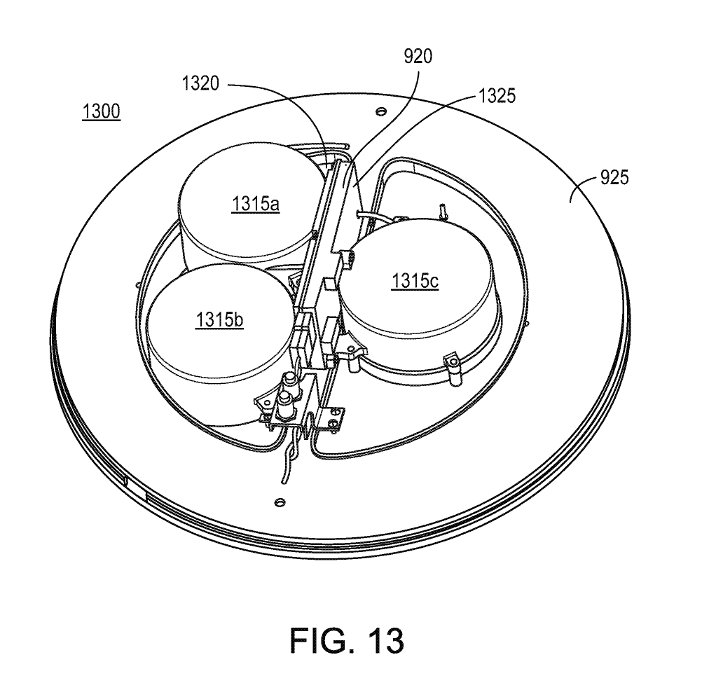

FIG. 5 shows an example of a process 500 for analyzing data from a sensor head that includes a radar and a metal detector. The process 500 may be performed by one or more processors associated with the system 100, the sensor head 105, or the sensor head 150. The process 500 may be performed by one or more processors associated with the sensor head 910 (FIGS. 9B and 10B), the sensor head 1200A (FIG. 12A), the sensor head 1200B (FIG. 12B), or the sensor head 1300 (FIG. 13). The process 500 may be performed on data that was previously collected by these systems and/or sensors and stored for later use. The process 500 accepts data from a GPR (such as the GPR 129) and a metal detector (such as the CWMD 133), and the process 500 includes GPR-only processing path 505. The GPR-only processing path 505 is discussed in greater detail in FIGS. 7A and 7B.

To address challenges posed by processing techniques used in some prior systems, a parallel path is employed so the data from the GPR and the CWMD may be fused or not fused. If the data is not fused, the data from each of GPR and the CWMD may be considered to be used independently. For example, the process 500 allows GPR-only processing (such as in the GPR-only processing path 505), CWMD-only processing, or both. Other sensors may be used.

The GPR-only processing technique may be optimized for bulk zero-metal or low-metal IED detection and discrimination. The GPR-only processing alarms indicate the presence of a target or potential target on objects several inches or more in size (in any dimension), at any detectable depth (for example, up to several feet below the surface of the ground), composed mostly of dielectric material, and with low or zero metal content. Some implementations provide instant detect alerts over the GPR targets. In some implementations, the system 100 also may (or alternatively) includes processing that determines whether an improvised explosive device (IED) is present.

Operation of the system 100 may be sensitive to the precision of the operator swing motion as well as to surface artifacts such as foot prints and vehicle tracks. Range sidelobes are generated in the range (or time) domain as part of IFFT processing and, although the IED processing analyzes regions separated from (that is, away from) the air/ground interface, the range sidelobes from the air/ground interface may still extend into all ranges. As a result, a swing artifact may be inadvertently reported to the user as a detection.

In some implementations, the IED detection processing employs a change detection aspect that uses principal component analysis (PCA). The PCA maps the data from the sensor or sensors in the sensor head into a new coordinate space whereby the first coordinate is in the direction of maximum variance, the second coordinate is in the direction of the second largest variance, and so on. From the principal component analysis, a measured variance is obtained within each newly transformed coordinate. The measured variance may be used to model the ground clutter. During operation of the system 100, each radar packet may be transformed to the new coordinate space and compared against the model to determine if the radar packet represents an “outlier”, and if so, a change detection is reported.

In some implementations, two simultaneous change detection algorithms are run, one focused on the detection of targets and one focused on the changes occurring specifically at the air/ground interface. By comparing the responses from these two change detection algorithms, it may be determined whether a detection is generated at an appropriate range for the target or if the detection is another fluctuation. Both swing artifacts and ground surface fluctuations should generate stronger change detection outputs at the air/ground interface while targets should generate a stronger response below the air/ground interface.

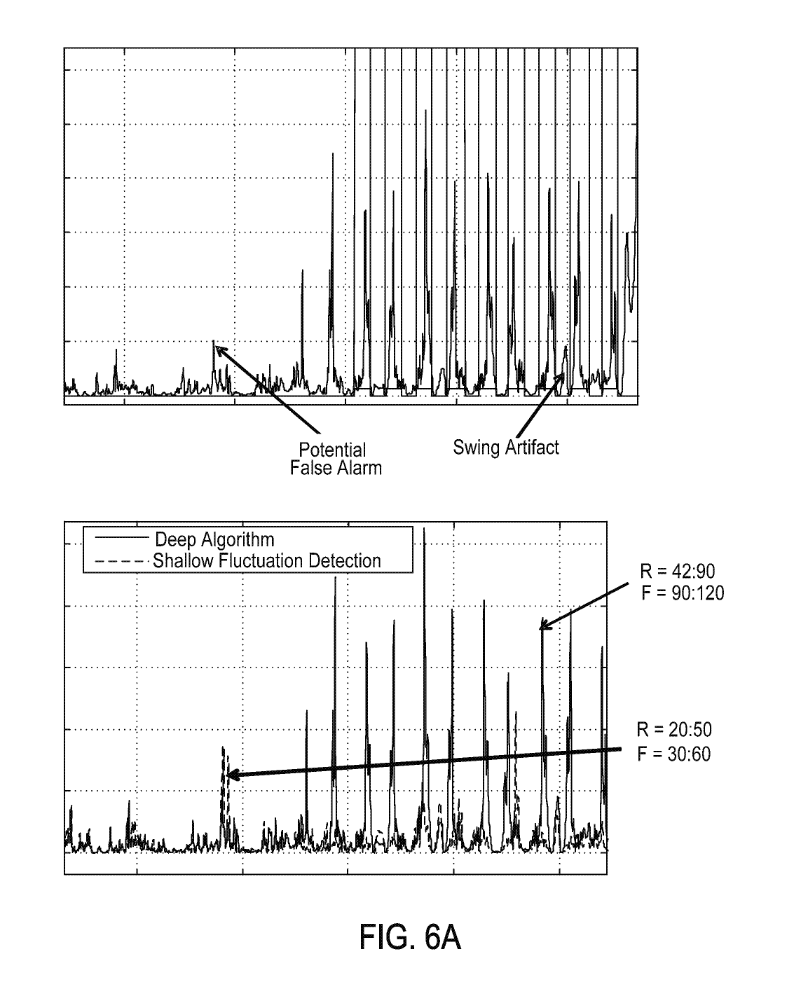

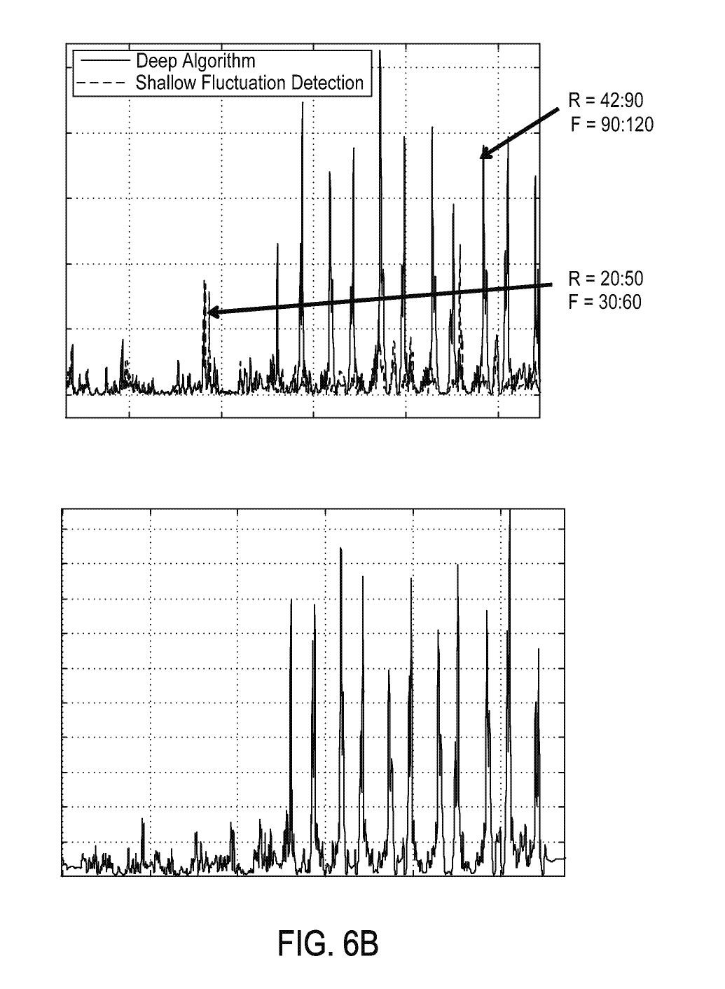

The following illustrates how the ratio test acts to reduce potential false alarms. FIG. 6A shows a potential false alarm and swing artifact evident as spikes in the change detection algorithm output.

FIG. 6B shows an example result after performing a ratio test between the target and surface response. In these examples, the swing artifacts as well as strong false alarm response are both reduced.

Referring to FIG. 7A, an example process 700A for detecting items such as IEDs and small wires is shown. Referring to FIG. 7B, a block diagram of another example process for detecting items such as IEDs and small wires is shown. The examples shown in FIGS. 7A and 7B may be performed using data from a ground penetrating radar (GPR), and the process 700A or 700B may be implemented in the “GPR-only Processing” path 505 shown in FIG. 5.

Each of the processes 700A and 700B may be performed by one or more electronic processors included in the system 100 or in communication with the system 100, the sensor head 105, or the sensor head 150. The processes 700A and 700b may be performed by one or more processors associated with the sensor head 910 (FIGS. 9B and 10B), the sensor head 1200A (FIG. 12A), the sensor head 1200B (FIG. 12B), or the sensor head 1300 (FIG. 13).

In some implementations, the GPR collects data in the frequency domain. That is, the GPR produces radar signals at multiple frequencies and measures an amplitude and/or phase of a signal return from a surface of the ground and from items in or under the surface of the ground at each frequency. Accordingly, the data from the GPR may be considered to be in the frequency domain. As discussed below, the frequency-domain data may be used directly (that is, without being transformed into the time domain) as part of a determination of whether an item is present on, within, or under a surface of the ground.

The frequency-domain data from the GPR may be used to generate one or more models that allow suppression of false alarms that may arise from environmental artifacts, such as surface characteristics (for example, tire ruts or footprints), and from motion artifacts, such as artifacts caused by unexpected motion of an operator of the GPR. A false alarm is a detection that is incorrectly classified as a target (such as a buried IED). Incorrectly classifying a benign object (such as surface roughness) as a target may cause a reduction in performance. For example, detections classified as targets may be subject to further examination by an operator of the system. Thus, the presence of incorrectly classified benign objects may cause an increase in the amount of time required to scan a particular area. Using the frequency-domain data from the GPR as discussed below may result in the number of false alarms being reduced by a factor two or more, leading to a performance improvement. In some implementations, for example, the improvement may be three or four fold, or perhaps more.

The techniques discussed with respect to FIGS. 7A and 7B may reduce the number of false alarms by generating several ground models during a training phase and arithmetically combining their Mahalanobis (M) Distance during a testing phase (when additional data is received) to identify anomalies buried under the ground. Initially, N Stepped-Frequency Continuous Wave (SFCW) Ground Penetrating Radar (GPR) frequencies are transmitted into the ground. The signal return (or ground return) of those frequencies is stored as frequency-domain data and the Inverse Fast Fourier Transform (IFFT) is used to generate a time (range) domain data representation. A set of K ground models are generated, where K is an integer value, and (K-2) number of the K ground models represent signals where targets of interest are likely to be found from a range domain standpoint (the K-2 models may be referred to Target Ground Models). The remaining two ground models of the K ground models represent signals where sources for clutter are found or are likely found. The two clutter ground model sources are the ground model representing the ground surface (in the range domain) and a frequency coupling ground model (in the frequency domain). The frequency coupling ground model represents the frequencies that are excited when an operator exhibits swing fluctuations.

All of the K ground models may be analyzed with an outlier rejection processing stage, where the ground return is analyzed to identify if a sample packet is an outlier from the rest of the training data packets. A sample packet or a packet may be a signal return or a ground signal return. The mean (average) value and the standard deviation of the amplitude and/or phase of the signals in each of the K ground models may be computed, and an outlier packet may be any particular signal that is one or more standard deviations less than or greater than the average value. Once outliers have been removed from the dataset, Principle Components Analysis (PCA) processing is performed on each ground model and the largest V singular values and components are saved for the testing processing stage, where V is a positive integer number. Also, a retraining processing phase may be spawned after a threshold number of non-outlier packets have been collected through the testing phase. The retraining processing phase updates all K ground models. The threshold number of non-outlier packets may correspond to a number of packets that are detected by the system in ten seconds of typical operation.

During the Testing Phase, each packet is projected into the PCA space of each of the K ground models. The M distance of each ground model is computed using only the largest V components of the ground models. Finally, a fusion processor computes a Signal-to-Clutter metric based on the M Distance of all ground models where an arithmetic combination of the target ground models is divided by an arithmetic combination of the clutter ground models. A Fused M Distance Metric Threshold is computed using the Fused M Distance Metric output and an IED detection is triggered via the IED Detection Alert when the Fused M Distance exceeds the Fused M Distance Threshold for a predetermined period of time.

FIG. 7A shows an example of process 700A used to process frequency-domain data. The process 700A may be performed by one or more processors included in, or in communication with, a system that includes a GPR, such as the system 100.

Frequency-domain data that represents a spatial region is accessed (701). The frequency-domain data may include, for example, an amplitude and phase of a radar return generated by directing multiple-frequency radiation from a ground penetrating radar at the surface of the Earth and detecting the return that is reflected from the surface and subsurface regions at each of the multiple frequencies. The generated radiation and the reflected return may include, for example, 140 discrete frequencies or discrete frequency bands.

The frequency-domain data may be accessed from an electronic storage that stores frequency-domain data collected during a previous data collection, or the frequency-domain data may be data that is collected by the GPR and stored in a temporary buffer for subsequent, though near-real time, analysis. In some implementations, the frequency-domain data is accessed by being provided by the system 100 to a separate electronic processor for analysis.

Time-domain data representing the spatial region is generated from the frequency-domain data (702). The spatial region may be the surface of the ground and regions beneath the surface of the ground to a depth of penetration of the radar signal. The time-domain data may be generated by, for example, performing an inverse Fourier transform on the frequency-domain data. The time-domain data represents an amplitude of the radar signal as a function of time. Because the time for the radar return signal to reach the detector correlates with the depth from which the return signal emanates, the time-domain data also may be referred to as range-domain data that represents the strength of the radar return as a function of depth beneath the surface (or distance from the sensor).

A first model is determined based on the accessed frequency-domain data (703). The first model may be referred to as a coupling ground model, and the first model is in the frequency domain. The coupling ground model identifies those frequencies (within the multiple frequencies that are included in the radar signal) that are excited in response to operator-induced artifacts in the data, such as artifacts caused by operator jitter and/or incorrect operator motion of the sensor. As discussed below, the first model is used to divide, reduce, minimize, or remove the frequencies that are excited or otherwise enhanced by unexpected operator motion. In other words, the first model is used to reduce or eliminate clutter that arises from the motion of an operator of the system 100.

A second model is determined based on the generated time-domain data, and the second model is associated with a particular range within the spatial region (704). The second model may include more than one model, and, the total number of first and second models together may be an integer number “K.” Collectively, the first and second models may be referred to as the “K ground models.” The second model includes a model of the surface of the ground (“surface ground model”), which is determined from time-domain (range-domain) data that is reflected from the surface. The surface model includes one or more time-domain signals that are representative of a signal returned from the surface of the ground.

The second model also may include one or more models that are associated with a particular sub-surface region. Each of these models may be referred to as a “ground target model,” and each model represents signals where targets of interest are likely to be found from a range-domain perspective. For example, one model may represent a region from just below the surface to a depth of several inches, and another model may represent a region that is deeper than a depth of several inches.

An initial background model is generated based on the first model and the second model (705). The background model represents a background of the region, and the background may be considered to be everything in the region other than targets. Thus, the background includes natural features such as soil and rocks, and the background may vary with the environment. To determine the background model, each of the K ground models may be processed with principal components analysis (PCA) to determine which of the frequencies contributes the most to the K ground models (that is, those frequencies that tend to change the most in the presence of a background or a target). The largest “V” singular values and components of the K ground models from the PCA are stored for later use, where “V” is a positive integer value. In some implementations, each of the K ground models is analyzed for outliers, and any outliers are removed before the initial background model is generated.

An additional frequency-domain signal is received (706). The additional frequency-domain signal may be received after the initial background model is generated. For example, the additional frequency-domain signal may be radar returns received as the system 100 travels through a region to scan the region for IEDs. The additional frequency-domain data may be any raw sensor data that is in the frequency-domain. In some implementations, the additional frequency-domain signal is analyzed to determine whether the additional frequency-domain signal is an outlier. When the number of additional frequency-domain signals that are not outliers exceeds a predetermined number, each of the K ground models are recomputed. Because the background may change when, for example, the system 100 travels from a region that is unimproved to a region (such as a paved road) that is improved, recalculating the K ground models may further improve performance. The number of non-outliers needed to exceed the predetermined number may correspond to the number of data packets (or return signals) received in a predetermined time under typical operating conditions of the GPR (or other sensor). For example, the predetermined number may be set such that the K ground models are updated, for example, approximately every few seconds, approximately every few minutes, or approximately every hour. In some other implementations, the update time may vary according to the environment in which the system 100 is operating. If the environment remains generally unchanged, then updates to the K ground models are relatively small.

The additional frequency-domain signal is compared to the initial background model (707) to determine how similar the additional frequency-domain signal is to the initial background model. A greater dissimilarity indicates a higher likelihood that the additional frequency-domain signal represents a target rather than the background. In some implementations, to determine the similarity between the background model and the additional frequency-domain signal, the Mahalanobis distance (M-distance) of each of the K ground models computed using only the largest “V” components of the K ground models found in (705). A signal-to-clutter metric (SCM) based on the M-distance may be determined. In some implementations, the signal-to-clutter ratio is determined from an arithmetic combination of the target ground models is divided by an arithmetic combination of the clutter ground models (the surface ground model and the coupling ground model) according to Equation 1:

SCM=SUM(target ground models)/(surface ground model+coupling ground model).

Whether the received signal represents a target is determined (708). Application of a threshold to a metric, such as the M-distance and/or to the SCM may indicate whether a target is present or not. If the metric is above or equal to the threshold, a target is present. If a target is determined to be present, an alarm may be activated. The alarm may be, for example, a visual alarm and/or an audible alarm. In some implementations, the alarm is activated when the metric exceeds the threshold for a predetermined amount of time.

Referring to FIG. 7B, a block diagram of another example process 700B is shown. The example process 700B includes a training phase 712, a testing phase 713, and a retraining phase 714. Sensor data that includes data at N different frequencies is input into the training phase 712. The sensor data may be data from a ground penetrating radar. An inverse Fourier transform of the sensor data is performed (710), and the resulting time (range) domain data is used to determine K number of ground models 715. In this example, K is a positive integer greater than two. The K ground models 715 include a surface ground model 716, (K-2) target ground models 717, and a coupling ground model 718.

The surface ground model 716 is a time-domain model of radar signals reflected from the surface of the ground. Each of the target ground models 717 includes signals from a particular subsurface region. For example, one target ground model may represent a region one to two centimeters below the surface and another target ground model may represent a region seven to ten centimeters below the surface. The coupling ground model 718 is a frequency-domain model derived directly from the sensor data, and the coupling ground model 718 represents the frequencies that are excited when, for example, an operator of the system 100 causes unexpected swing fluctuations. Together, the surface ground model 716 and the coupling ground model 718 may be considered “ground clutter models.”

The K ground models are analyzed with an outlier rejection process 720. The surface return signals in each of the K ground models is analyzed to determine whether a particular signal is an outlier compared to the remaining signals. Any outliers that are found are removed from the K ground models, and the K ground models are analyzed with principal component analysis (PCA) 730. The PCA processing determines the largest “V” singular values and components (the frequencies that cause the most variance in the data), and these components are saved for the testing phase 713. The initial ground model 740 is generated based on the results of the PCA. The initial ground model 740 is made available for use during a testing phase 713.

During the testing phase 713, additional sensor (GPR) data, similar to the sensor data used in the training phase 712 but collected at a later time, is analyzed to determine whether the additional sensor data includes a target (such as a buried IED or a small wire used to detonate an explosive). A PCA projection/M distance computation module 750 performs a PCA projection and determines an M distance for each of the K ground models. Each packet of GPR data is projected into the PCA space of each of the K ground models, and the M distance of each ground model is computed using only the largest “V” components found during the PCA processing of the K ground models. A fusion processor 760 determines a signal-to-clutter metric (SCM) based on the M distance of each of the K ground models. The SCM may be determined using Equation 1. A threshold is applied to an output 770 of the fusion processor 760. If the output 770 meets or exceeds the threshold, the GPR data packet is sufficiently different from the background to be deemed a target. Otherwise, the GPR data packet is not deemed a target.

In some implementations, a retraining phase 714 is triggered when a threshold number of non-outlier data packets are received. The recompute ground models module 780 causes the K ground modules 715 to be regenerated based on data that the GPR is currently, or has recently, produced.

Although the examples discussed with respect to FIGS. 7A and 7B are primarily related to GPR, the processing is applicable to other types of sensors as well. Further, the IED processing discussed above may be used in combination with other GPR processing techniques and techniques used to process data from other sensors.

The above examples discuss the benefits of example processing techniques that, when applied to GPR data, may improve detection of IEDs and small wires. Additionally, a CWMD, used alone or in combination with a GPR, also may be used to detect IEDs and small wires.

Some IED threats contain minimum or zero metal content as well as types of metal that are not easily detectable—if at all—by available pulsed metal detector (MD) systems. The continuous wave metal detector (CWMD), such as the CWMD discussed above, may provide detection of metals and fusing methods that pulsed systems cannot. For example, the CWMD may detect non-ferrous metals such as many types of stainless steel/titanium, wires used to detonate IEDs (for example, simple speaker wire), and threats that may be hidden or shadowed by neighboring metal in doorways or simply by metal debris. In some implementations, the CWMD transmits over twenty-one frequencies (in a frequency range of, for example, 300 Hz-180 kHz) through a dedicated transmit coil and continuously receives all frequencies using a dedicated receive coil. The CWMD's 24-bit dynamic range conversion supports compensating for both fixed nearby metal (such as the GPR antennas and the sensor head mounted transceiver board) as well as dynamic sources, such as mineralized soils, in real time.

The coherent MD (or CWMD) design also achieves may achieve lower noise operation and may allow the generation of an expanded feature space via processing of in-phase (I) and quadrature (Q) signals just as from the GPR. This may provide increased performance, and this additional information provides improved discrimination.

In some implementations, the data from the CWMD may be determined as detections purely from the signal being a specified level above the computed background. The signal may be computed as the average amplitude from a subset of twenty-one frequencies measured.

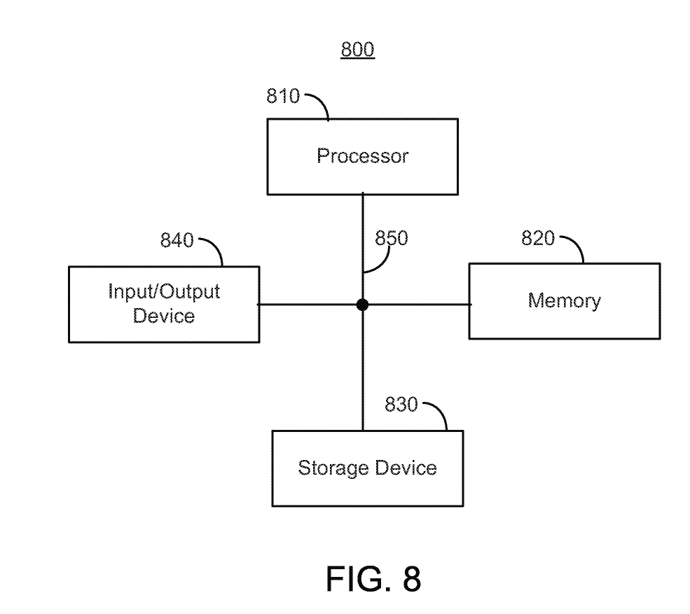

FIG. 8 is a block diagram of a computer system 800 that can be used in the operations and systems described above, according to one implementation. The system 800 includes a processor 810, a memory 820, an electronic storage 830 and an input/output interface 840. Each of the components 810, 820, 830 and 840 are interconnected using a system bus 850. The processor 810 is capable of processing instructions for execution within the system 800. In some implementations, the processor 810 is a single-threaded processor. In another implementation, the processor 810 is a multi-threaded processor. The processor 810 is capable of processing instructions stored in the memory 820 or on the electronic storage 830 to display graphical information for a user interface on the input/output interface 840. The processor 810 may be coupled to another element, such as a sensor within the sensor head 105, 150 by being electrically coupled to the sensor and able to exchange data and signals with the sensor.

The memory 820 stores information within the system 800. In one implementation, the memory 820 is a computer-readable medium. In another implementation, the memory 820 is a volatile memory unit. In still another embodiment, the memory 820 is a non-volatile memory unit.

The electronic storage 830 is capable of providing mass storage for the system 800. In one embodiment, the storage device 830 is a computer-readable medium. In various different embodiments, the storage device 830 may be a floppy disk device, a hard disk device, an optical disk device, or a tape device.

For example, the system 100, discussed previously with respect to FIGS. 1A-1E, may include the processor 810 executing computer instructions that are stored in one of memory 820 and storage device 830.

The input/output device 840 provides input/output operations for the system 800. In one implementation, the input/output device 840 includes a keyboard and/or pointing device. In another implementation, the input/output device 840 includes a display unit for displaying graphical user interface as discussed above.

The techniques can be implemented in digital electronic circuitry, or in computer hardware, firmware, software, or in combinations of them. The techniques can be implemented as a computer program product, that is, a computer program tangibly embodied in an information carrier, in a machine-readable storage device, in machine-readable storage medium, in a computer-readable storage device, in computer-readable storage medium, or in a propagated signal, for execution by, or to control the operation of, data processing apparatus, such as a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, on, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

FIG. 9A shows a perspective view of another cover 902 for a sensor head that may be used in a detection system such as the detection system shown in FIGS. 1A-1D. FIG. 9B shows a perspective view of a sensor head 910 that may be used in a detection system.

The sensor head 910 includes a GPR 915, a transceiver 920, and a CWMD 925. The CWMD 925 may be similar to the CWMD 133 discussed above in, for example, FIG. 1E. The CWMD 925 includes a top shield 940, a foam layer 941, a coil 942, a foam layer 943, and a bottom shield 944. The coil 942 includes a transmit coil (not shown) and a receive coil (not shown). In the example of FIG. 9B, at least part of each of the transmit and receive coils are positioned along a perimeter region 911, and the transmit and receive coils are positioned between the CWMD top shield 940 and the bottom shield 944. The top shield 940 and the bottom shield 944 may shield the coil 942 from electromagnetic interference. The top shield 940 and the bottom shield 944 include metallic materials or wire traces (not shown) that provide the shielding for the coil 942.

The GPR 915 includes a receive antenna 915a and a transmit antenna 915b, each of which are connected to the transceiver 920. The transceiver 920 may be considered to be included in the GPR 915; however, the transceiver 920 may be considered to be a separate element. In the example shown in FIG. 9B, the transceiver 920 is positioned between the antennas 915a and 915b, and the transceiver 920 is electrically connected to the antennas 915a and 915b through an interface 919. The interface 919 may be any suitable interface that provides an electrical connection between the antennas 915a and 915b and the transceiver 920, and the interface 919 may include a conducting wire.

The transmit antenna 915a and the receive antenna 915b are supported and/or held by a grid 914 that provides stiffness and provides a bottom cover to the sensor head 910. The grid and bottom cover 914 may be, for example, a plastic or another material that is firm, rugged, and electrically non-conductive. One side of the grid and bottom cover 914 may be smooth and form the bottom surface of the sensor head 910. Openings 916 in the grid 914 may receive fasteners (such as screws and bolts) that hold various components (such as the antennas 915a and 915b) to the grid 914 so that the components are held in the sensor head 910.

The cover 902 may fit over the components of the sensor head 910 to protect the components. The cover 902 may attach to a wand, such as the wand 107, or another object used to hold the sensor head 910. The cover 902 also may attach to the sensor head 910. For example, openings 903 in the cover 902 may be used to attach the cover 902 to the sensor head 910. A lip or ring 904 on the cover 902 may attach to a corresponding lip or ring on a lower surface 945 of the sensor head 910 to secure the cover 902 to the sensor head 910. In operation, the cover 902 may be placed over the sensor head 910. The sensor head 910 may be operated without the cover 902 present. The cover 902 includes protruded portions, such as the portion 906, to accommodate the components of the sensor head 910, such as the transceiver 920 or to provide stiffness.

FIG. 9C shows a plan view of the coil 942 of the CWMD 925. The coil 942 also may be referred to as a transmit and receive coil 942. The coil 942 may be made out of plastic or another material that is electrically non-conductive. The coil 942 includes a transmit coil winding 946, a first receive coil winding 947, and a second receive coil winding 948. The windings 946, 947, and 948 are electrically conductive and may be formed or attached to the material that makes the coil 942. The transmit coil winding 946 produces electromagnetic radiation and the receive coil windings 947 and 948 sense electromagnetic radiation. The transmit coil winding 946 is positioned in a region adjacent to the perimeter of the sensor head 910. For example, the transmit coil winding 946 may be positioned in the perimeter region 911 (FIG. 9B). The receive coil windings 947 and 948 are formed as half-circles, with the middle portions positioned near the center line of the sensor head 910. Portions of each of the receive coil windings 947 and 948 may be positioned in the perimeter region 911. The receive coil 947 and the receive coil 948 may be positioned on opposite sides of the plastic that forms the coil 942.

FIG. 9D shows a bottom plan view of the bottom shield 944. FIG. 9E shows a plan view of the bottom side of the grid and bottom cover 914. The bottom side of the grid and bottom cover 914 is smooth. The grid and cover 914 are made from a material through which radiation in the frequency bands of the antennas 915a and 915b and the coil 942 penetrates such that the sensor head 910 operates with the grid and bottom cover 914 in place. In operation of the sensor head 910, the bottom side of the grid and bottom cover 914 is pointed towards a region of interest to be scanned, and radiation is transmitted through the bottom cover 914 towards the region of interest and radiation from the region of interest is received through the bottom cover 914. For example, in a countermine application, the bottom side of the bottom cover 914 is oriented towards the ground.

FIGS. 10A and 10B show the transceiver 920 disconnected from the GPR 915 and the sensor head 910. The transceiver 920 includes an interface 922 that connects to a connector 912 of the sensor head 910. The interface 922 may be configured to receive a Universal Serial Bus (USB) connector, and the connector 912 may be a USB connector. When the transceiver 920 couples to the connector 912 through the interface 922, the transceiver 920 is electrically connected to the electronics 135a. The transceiver 920 is directly connected to the antennas 915a and 915b through the interface 919 (FIG. 9B). Although the sensor head 910 is shown as connecting to the transceiver 920, the sensor head 910 may connect to other transceivers through the connector 912. In some implementations, the sensor head 910 may be retrofit to connect to other transceivers through a connector other than the connector 912.

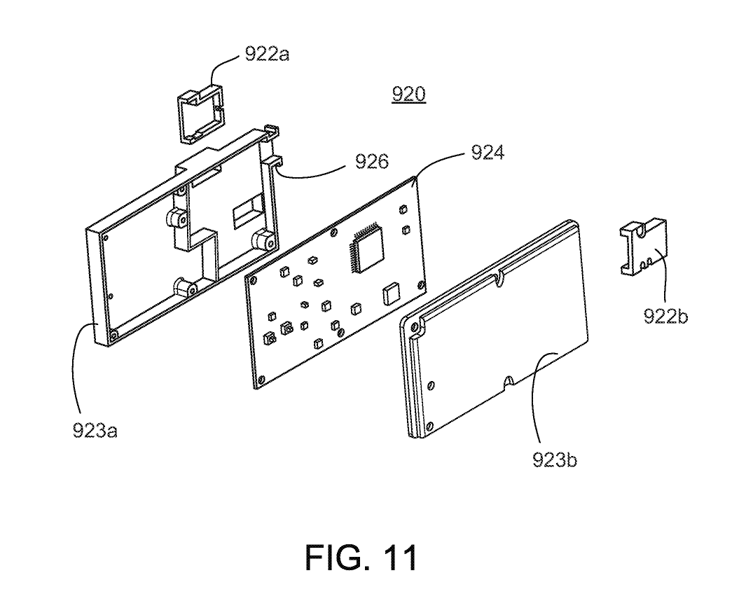

FIG. 11 shows an exploded view of the transceiver 920. The transceiver 920 includes the interface 922 (FIGS. 9B and 10B), a housing 923, and electronics 924. In the example shown, the interface 922 is formed from two portions, 922a and 922b. The housing 923 is formed from two pieces, 923a and 923b that, when joined, form the housing 923 to enclose the electronics 924. The piece 923a includes a flange 926 that is shaped to receive one or more of the portions 922a and 922b.

In the example shown, the housing 923 is an all-metal housing and the housing pieces 923a and 923b are made entirely of metal. Enclosing the transceiver 920 in the all-metal housing 923 improves the sensitivity and performance of the CWMD 925 while maintaining the discrimination abilities of the CWMD 925. For example, the all-metal housing 923 may shield the transceiver 920 from radiation emitted by the CWMD 925. The housing 923 may reduce or eliminate electromagnetic emissions from the transceiver 920, thus shielding the CWMD 925 from radiation emitted from the transceiver 920. The performance of the CWMD 925 may improve when noise, such as spurious radio transmissions, is reduced. Thus, placing the transceiver 920 in an all-metal housing may improve performance of the CWMD 925 and the overall performance of a detection system that includes the CWMD 925.

FIG. 12A shows another example sensor head 1200A. The sensor head 1200A includes the transceiver 920, the CWMD 925, and a GPR 1215. The GPR 1215 includes a transmit antenna 1215a and a receive antenna 1215b. In the example of FIG. 12A, the antennas 1215a and 1215b are elongated spiral antennas, and the transceiver 920 is positioned between the antennas 1215a and 1215b. The transceiver 920 is electrically connected to the antennas 1215a and 1215b and to the electronics 135b.

As compared to a spiral antenna, using the elongated spiral antennas 1215a and 1215b may increase the area of sensitivity (or sensitive area) of the GPR 1215 and/or the sensor head 1200A by transmitting and receiving radar radiation from a larger area beneath the antennas 1215a and 1215b. In other words, if the sensor head 1200A is used to scan a region of interest (not shown) that is larger than the sensor head 1200, the antennas 1215a and 1215b may increase the size of a portion of the region of interest that the antennas 1215a and 1215b are able to scan at a given moment. For a hand-held or operator-movable detection system, increasing the area of sensitivity may help to mitigate and/or reduce operator gapping (unintentionally un-scanned portions of the region of interest or gaps).

FIG. 12B shows another example sensor head 1200B. The sensor head 1200B includes a GPR 1216, the transceiver 920, and the CWMD 925. The GPR 1216 includes a transmit antenna 1216a and a receive antenna 1216b. Each of the transmit antenna 1216a and the receive antenna 1216b are oriented (or tilted) towards each other at an angle θ relative to the normal of the bottom of the sensor head 1200B. The angle may be referred to as the tilt angle. The tilt angle may be any angle greater than 0°. For example, the tilt angle may be between 5° and 20°.

As a result of the tilting, the active areas of the antenna 1216a and the antenna 1216b are angled towards each other. The antennas 1216a and 1216b may have the same tilt angle, different tilt angles, or the tilt may be applied to one antenna while the remaining antenna maintains a 0° tilt. Regardless, the tilt is applied such that the active area of the antennas 1216a and 1216b are oriented at least partially towards each other. Applying the tilt to either or both of the antennas 1216a and 1216b may result in an increased depth and size of the sensitive area (which may be considered as an area over which the sensor head 1200B scans at any given time), which may lead to enhanced system performance.

FIG. 13 shows another example sensor head 1300. The sensor head 1300 includes the transceiver 920, the CWMD 925, and a GPR 1315. The GPR 1315 includes antennas 1315a, 1315b, and 1315c. Two of the antennas of the GPR 1315 receive radar radiation, and one of the antennas of the GPR 1315 transmits radar radiation. In the example shown, the antennas 1315a and 1315b receive radar radiation, the antenna 1315c transmits radar radiation, and the transceiver 920 is positioned such that the antennas 1315a and 1315b are on a first side 1320 of the transceiver 920 and the antenna 1315c is on a second side 1325 of the transceiver 920. The presence of two receive antennas may increase the sensitive area of the GPR 1315, and, thus, may improve performance of the GPR 1315 and the detection system that includes the GPR 1315.

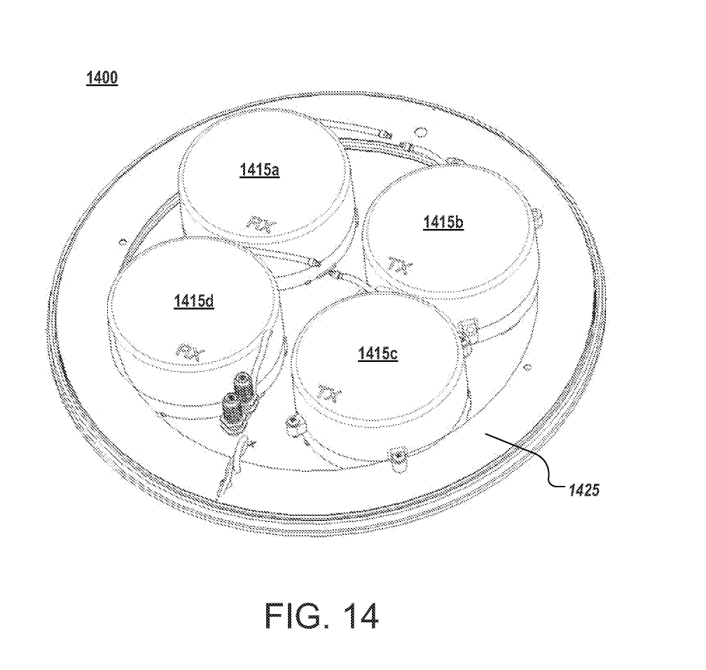

FIG. 14 shows another example sensor head 1400. The sensor head 1400, in the illustrated configuration, depicts a metal detector coil 1425 (e.g., a CWMD or pulsed metal detector) that includes transmit coil windings and receive coil windings positioned concentric with each other and stacked one on top of the other in a dipole configuration. This configuration provides a larger area in the center for the GPR antennas. For example the larger area can include four GPR antennas as shown in FIG. 14 where there are two transmit antennas 1415b, 1415c and two receive antennas, 1415a, 1415d and this configuration may increase even further the sensitive area of the GPR and may improve the performance. The metal detector coil windings may be either circular or elliptical depending on the search requirements and fusion with other sensors. They may alternatively be of a single wire loop of any type of pulsed metal detector commonly available.

A number of implementations of the techniques have been described. Nevertheless, it will be understood that various modifications may be made without departing from the spirit and scope of the claims. For example, useful results still could be achieved if steps of the disclosed techniques were performed in a different order and/or if components in the disclosed systems were combined in a different manner and/or replaced or supplemented by other components.

For example, although the system shown in FIG. 1A is a handheld system intended to scan the surface of the ground, the sensor head 105 may be mounted on a fixed platform (such as a portal) through which persons pass and are scanned for harmful objects. The sensor head 105 may be used to scan persons or luggage for explosives, small wires, and metal.

Instead of being mounted on the wand 107, the sensor head 105 may be mounted on a vehicle, a platform that is manually or robotically operated, or a movable cart. In these implementations, the cable 109 is used to communicate data to and/or from the sensor head 105 to electronics associated with the vehicle, platform, or movable cart. The sensor head 150 also may be mounted in any of these configurations and used in any of these situations.

In some implementations, the wand 107 may be non-collapsible. For example, the wand 107 may be a fixed-form wand used to scan human persons for hazardous objects. The sensor head 105 may be mounted on a fixed platform such that the sensor head 105 scans objects as the objects pass through the range of the sensors in the sensor head 105.

The sensor head 105 may include the quadrapole CWMD 133 without a GPR or other type of radar, and the sensor head 105 may include the dipole metal detector 1425 (e.g., a CWMD) without a GPR or other type of radar. In yet other implementations, the sensor head 105 includes only the GPR 129 and the transceiver 127 that allows for simplified cabling. In some implementations, the sensor head 105 may be replaced with a second sensor head including a pulsed metal detector. The second sensor head may, in some implementations, include a GPR in addition to the pulsed metal detector.

The processing techniques discussed with respect to, for example, FIGS. 2, 3, 4, 7A, and 7B may be applied to data collected by and received from the sensors included in the sensor head 105, 150, 910, 1200A, 1200B, and/or 1300 but stored for later analysis or the processing techniques may be applied during operation of the system 100 and the sensor head 105, 150, 910, 1200A, 1200B, and/or 1300.

The housing 923 may be a housing that is formed of a single, unitary piece that encloses the electronics 924 but does not include the pieces 923a and 923b. The single-piece housing may be an all-metal housing or a metalized plastic housing. The housing 923 shown in the example of FIG. 11 is an all-metal housing. The housing 923 may be all metal if the housing is completely made of metal or includes only incidental amounts of non-metallic material. However, in some implementations, the housing 923 may be a metalized plastic housing. In these implementations, one or more of the pieces 923a and 923b include plastic. The all-metal housing 923 of the transceiver 920 may be positioned flat on the antennas 915a and 915b rather than positioned between the antennas 915a and 915b. The wand 107 and cover 902 may be made of plastic or carbon fiber with the particular material chosen to prevent blocking target frequencies of the GPR or CWMD. FIG. 12B shows a tilt angle is shown as being applied to antennas 1215a and 1215b. However, one or more antennas included in other sensor heads (such as the sensor head 105, 910, and 1310) may be tilted.

Each of the sensor heads 105, 150, 910, 1200A, 1200B, and 1300 may include any type of radar instead of, or in addition to, a ground penetrating radar, and the sensor heads and/or the radars in the sensor heads may include any suitable type of antenna such as, for example, printed/micro-strip antennas, wire antennas, and horn antennas.

Instead of being permanently affixed to the wand 107, the sensor head 105 may configured such that it is detachable from the wand 107. The fastener 106 may be a pin, a screw or any appropriate fastener. Alternatively, sensor head 105 and wand 107 may be designed to connect using a quick disconnect such that configured such that less than one complete turn is required to connect or disconnect the sensor head from the wand, for example. Any appropriate type of connection may be used to attach and detach the sensor head from the wand.

In this implementation, the cable 109 would also be configured with a detachable electrical connection. Furthermore, the electronics 135a and 135b in the housing 923 may be configured to operate with a pulsed metal detector sensor head. Alternatively the electronics 135a and 135b may be configured on removable circuit cards. In such an implementation the electronics 135a and 135b may be replaced with electronics compatible with pulsed metal detector sensor head or any appropriate handheld detection sensor.

What is claimed is:

1. An apparatus comprising:
a sensor head comprising:
a continuous wave metal detector having a transmit coil and a receive coil, and
a radar having one or more transmit antennas configured to transmit electromagnetic radiation, and one or more receive antennas configured to sense electromagnetic radiation, a transceiver operatively coupled to the radar, the transceiver being enclosed in a housing,
wherein the continuous wave metal detector is configured to transmit and receive radiation in the frequency band between 300 Hz and 180 kHz, and
the radar is configured to transmit and receive radiation in the frequency band between 100 MHz and 8 GHz.

2. The apparatus of claim 1, further comprising a wand coupled to the sensor head.

3. The apparatus of claim 1, wherein the transmit coil is positioned concentric with the receive coil in a dipole configuration.

4. The apparatus of claim 3, wherein the one or more transmit antennas and the one or more receive antennas are encircled by the transmit coil and the receive coil.

5. The apparatus of claim 1, wherein the transmit coil and the receive coil are arranged in a quadrapole configuration.

6. The apparatus of claim 1, wherein the continuous wave metal detector transmits and receives radiation on at least six different frequencies and up to forty-two different frequencies.

7. The apparatus of claim 1, wherein the radar comprises one transmit antenna and two or more receive antennas.

8. The apparatus of claim 1, wherein the radar comprises two or more transmit antennas and two or more receive antennas.

9. The apparatus of claim 1, wherein the radar is a ground penetrating radar.

10. The apparatus of claim 2, wherein the wand is comprised of plastic or carbon fiber.

11. The apparatus of claim 1, further comprising:
a support structure that receives the radar and the transceiver, the support structure comprising a plastic grid; and
a cover configured to enclose at least a portion of the transceiver, the radar and the continuous wave metal detector coils, the cover being comprised of plastic.

12. The apparatus of claim 1, wherein the housing enclosing the transceiver is coupled to the wand.

13. The apparatus of claim 1, wherein the housing enclosing the transceiver is located inside a sensor head.

14. A kit comprising:
a wand;
a first sensor head configured to attach to the wand, the first sensor head comprising:
a continuous wave metal detector having a transmit coil and a receive coil,
a radar having one or more transmit antennas configured to transmit electromagnetic radiation, and one or more receive antennas configured to sense electromagnetic radiation,
a transceiver operatively coupled to the radar, the transceiver being enclosed in a housing;
a second sensor head comprising a non-continuous wave metal detector, the second sensor head being configured to attach to the wand;
a processor configured to be operatively coupled to one or more of the first sensor head and the second sensor head;
a first memory configured to be operatively coupled to the first sensor head, the first memory including instructions that when executed cause the processor to:
access data from the continuous wave metal detector and data from the radar, and
determine a signature of an object detected by one or more of the continuous wave metal detector or the radar based on the accessed data; and
a second memory configured to be operatively coupled to the second sensor head, the second memory including instructions that when executed cause the processor to:
access data from the non-continuous wave metal detector, and
determine a signature of an object detected by the non-continuous wave metal detector.

15. The kit of claim 14, wherein the transmit coil and the receive coil are arranged in a quadrapole configuration.

16. The kit of claim 14, wherein the transmit coil is positioned concentric with the receive coil in a dipole configuration.

17. The kit of claim 16, wherein the one or more transmit antennas and the one or more receive antennas are encircled by the transmit coil and the receive coil.

18. The kit of claim 14, wherein the non-continuous wave metal detector of the second sensor head is a pulsed metal detector.

19. The kit of claim 14, wherein the continuous wave metal detector transmits and receives radiation on at least six different frequencies and up to forty-two different frequencies.

20. The kit of claim 14, wherein the continuous wave metal detector transmits and receives radiation in the frequency band between 300 Hz and 180 kHz.

21. The kit of claim 14, wherein the radar comprises one transmit antenna and two or more receive antennas.

22. The kit of claim 14, wherein the radar comprises two or more transmit antennas and two or more receive antennas.

23. The kit of claim 14, wherein the radar is a ground penetrating radar configured to transmit and receive radiation in the frequency band between 100 MHz and 8 GHz.

24. The kit of claim 14, wherein the wand is comprised of plastic or carbon fiber.

25. The kit of claim 14, further comprising:
a support structure configured to receive the radar and the transceiver, the support structure comprising a plastic grid; and
a cover configured to enclose at least a portion of the transceiver, the radar and the continuous wave metal detector,
the cover being comprised of plastic.

26. The kit of claim 14, wherein the housing enclosing the transceiver is coupled to the wand.

27. The kit of claim 14, wherein the housing enclosing the transceiver is located inside the first sensor head.
